(19) United States
(12) Patent Application Publication
(10) Pub. No.: US 2011/0291562 A1
(43) Pub. Date: Dec. 1, 2011

(54) LIGHTING DEVICE, DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/146,648

(22) PCT Filed: Nov. 17, 2009
(86) PCT No.: PCT/JP2009/069468

§ 371 Date: Jul. 28, 2011

(30) Foreign Application Priority Data
Feb. 25, 2009 (JP) 2009-042484

(51) Int. Cl. H01J 7/44

(52) U.S. Cl. 315/37

(57) ABSTRACT

A lighting device of the present invention includes a number of discharge tubes 17 that are arranged parallel to each other, and a power source 170 that supplies driving power for driving the discharge tubes 17 in parallel. The driving power is supplied to each of the discharge tubes 17 so that the driving power supplied to one end side of the discharge tube 17 and the driving power supplied to another end side of the discharge tube 17 are in opposite phases. A capacitor 56 is connected to the one end side of each of the discharge tubes 17 that are arranged in parallel to each other. The capacitor 56 is disposed between the power source 170 and each discharge tube 17 to make a current amount of the driving power that is supplied to each of the discharge tubes 17 to be constant.

### TECHNICAL FIELD

The present invention relates to a lighting device, a display device and a television receiver.

### BACKGROUND ART

In a display device using a non-light emitting optical component such as a liquid crystal display device, a backlight device is provided behind a display panel such as a liquid crystal display panel for illuminating the display panel (see Patent Document 1 as an example).

### PRIOR ART DOCUMENT

### Patent Document

[Patent Document 1] Japanese Laid-Open Patent Publication no. 2006-19260

### Problem to be Solved by the Invention

The backlight device disclosed in the above Patent Document 1 includes a configuration of CCFL that can be driven in parallel. The backlight device disclosed in Paten Document 1 includes a number of cold cathode tube lamps that are connected in parallel to each other, capacitors that are connected to two ends of each of the cold cathode tube lamps respectively to unify an amount of current supplied to the cold cathode tube lamps, and an inverter connected to each of the capacitors to supply drive power to the cold cathode tube lamps. With such a configuration, the CCFLs are driven in parallel to achieve uniform brightness. However, Patent Document 1 does not disclose a detailed arrangement of the capacitors with respect to the cold cathode tube lamps and only discloses a configuration in which the capacitor is connected to each end of the cold cathode tube.

### DISCLOSURE OF THE PRESENT INVENTION

The present invention was made in view of the foregoing circumstances, and an object thereof is to provide a lighting device that includes a configuration that drives a number of discharge tubes in parallel, and is inexpensive and excellent in operation ability.

Another object of the present invention is to provide a display device having such alighting device and a television receiver having such a display device.

### Means for Solving the Problem

To solve the above problem, a lighting device of the present invention includes a number of discharge tubes that are arranged parallel to each other, and a power source configured to supply driving power to drive the discharge tubes in parallel. The driving power is supplied to the discharge tubes so that the driving power supplied to one end side and another end side of each of the discharge tubes in opposite phases. A capacitor is connected to the one end side of the discharge tubes between the power source and each of the discharge tubes, and the capacitor is disposed between the power source and each of the discharge tubes to make a current amount of the driving power supplied to each of the discharge tubes to be constant.

With such a lighting device, the discharge tubes are able to be driven in parallel and the capacitor is connected to only the one end side of the discharge tubes. This reduces a cost compared to a configuration in which the capacitors are provided on two end sides of the discharge tubes.

### BRIEF DESCRIPTION OF THE DRAWINGS

FIG. 1 is an exploded perspective view illustrating a general construction of a television receiver of a first embodiment;

FIG. 2 is an exploded perspective view illustrating a general construction of a liquid crystal display device (a display device);

FIG. 3 is a cross-sectional view of FIG. 2 along the line A-A;

FIG. 4 is a front view illustrating a main construction of a backlight device (a lighting device);

FIG. 5 is a front view illustrating the main construction in FIG. 4 without cold cathode tubes;

FIG. 6 is a rear view illustrating a main construction of the backlight device;

FIG. 7 is a perspective view illustrating a construction of a first light source holding member;

FIG. 8 is a perspective view illustrating a construction of a second light source holding member;

FIG. 9 is an explanatory view illustrating a mechanism for supplying driving power to the cold cathode tubes on a first light source holding member side;

FIG. 10 is an explanatory view illustrating a mechanism for supplying driving power to the cold cathode tubes on a second light source holding member side;

FIG. 11 is an explanatory view illustrating a circuit configuration related to power supply;

FIG. 12 is a perspective view illustrating a construction of a clip terminal;

FIG. 13 is a perspective view illustrating a construction of the cold cathode tube;

FIG. 14 is a plan view illustrating a construction of a ferrule connected to the cold cathode tube;

FIG. 15 is a front view illustrating the clip terminal holding a cold cathode tube;

FIG. 16 is a plan view illustrating the clip terminal holding a cold cathode tube;

FIG. 17 is a perspective view illustrating a ferrule of one modification;

FIG. 18 is an explanatory view illustrating a mechanism that disconnects the chassis and the clip terminal;

FIG. 19 is an explanatory view illustrating a mechanism that disconnects the chassis and the clip terminal;

FIG. 20 is a front view illustrating a main construction of a lighting device included in a liquid crystal display device of a television receiver according to a second embodiment;

FIG. 21 is a front view illustrating the main construction of FIG. 20 without the cold cathode tubes;

FIG. 22 is a rear view illustrating the main construction of the lighting device;

FIG. 23 is a perspective view illustrating a construction of a first relay member;

FIG. 24 is a perspective view illustrating a construction of a second relay member;

FIG. 25 is an explanatory view illustrating a circuit configuration related to power supply on a first relay member side;

FIG. 26 is an explanatory view illustrating a circuit configuration related to power supply on a second relay member side;

FIG. 27 is a perspective view illustrating a construction of the cold cathode tube;

FIG. 28 is a cross-sectional view illustrating a construction of the cold cathode tube;

FIG. 29 is an explanatory view schematically illustrating a construction related to power supply;

FIG. 30 is a perspective view illustrating a construction of a relay body;

FIG. 31 is an explanatory view illustrating a state in which the cold cathode tube is being fitted to the relay body;

FIG. 32 is an explanatory view illustrating a state in which the cold cathode tube is fitted to the relay body;

FIG. 33 is a plan view illustrating a relay body of a modification;

FIG. 34 is a perspective view illustrating a relay member of a modification;

FIG. 35 is a front view illustrating a main construction of a lighting device included in a liquid crystal display device of a television receiver according to a third embodiment;

FIG. 36 is a front view illustrating the main construction in FIG. 35 without the cold cathode tubes;

FIG. 37 is a rear view illustrating the main construction of the lighting device;

FIG. 38 is a perspective view illustrating a construction of a first power relay board;

FIG. 39 is an explanatory view illustrating a mechanism for supplying driving power to the cold cathode tubes on the first power relay board side;

FIG. 40 is a perspective view illustrating a construction of a second power relay board;

FIG. 41 is an explanatory view illustrating a mechanism for supplying driving power to the cold cathode tubes on the first power relay board;

FIG. 42 is an explanatory view schematically illustrating a construction related to power supply;

FIG. 43 is a perspective view illustrating a construction of a relay electrode;

FIG. 44 is a perspective view illustrating a construction of a lamp holder;

FIG. 45 is a front view illustrating a state in which the cold cathode tube is placed on the relay electrode;

FIG. 46 is a plan view illustrating a state in which the cold cathode tube is placed on the relay electrode;

FIG. 47 is a perspective view illustrating a relay electrode of a modification;

FIG. 48 is an explanatory view illustrating a positional relation between the relay electrode in FIG. 47 and the cold cathode tube;

FIG. 49 is a perspective view illustrating a relay electrode of a modification;

FIG. 50 is an explanatory view illustrating a positional relation between the relay electrode in FIG. 49 and the cold cathode tube;

FIG. 51 is an explanatory view illustrating a construction when using the lamp clip;

FIG. 52 is a front view illustrating a construction of the lamp clip;

FIG. 53 is an explanatory view illustrating a lamp holder of a modification;

FIG. 54 is an explanatory view illustrating a lamp holder of another modification;

FIG. 55 is an explanatory view illustrating a relay electrode of one modification and a positional relation between the relay electrode and the cold cathode tube; and

FIG. 56 is an explanatory view illustrating a circuit configuration related to power supply that can be commonly used for the first to third embodiments.

### BEST MODE FOR CARRYING OUT THE INVENTION

### First Embodiment

An embodiment of the present invention will be explained with reference to drawings.

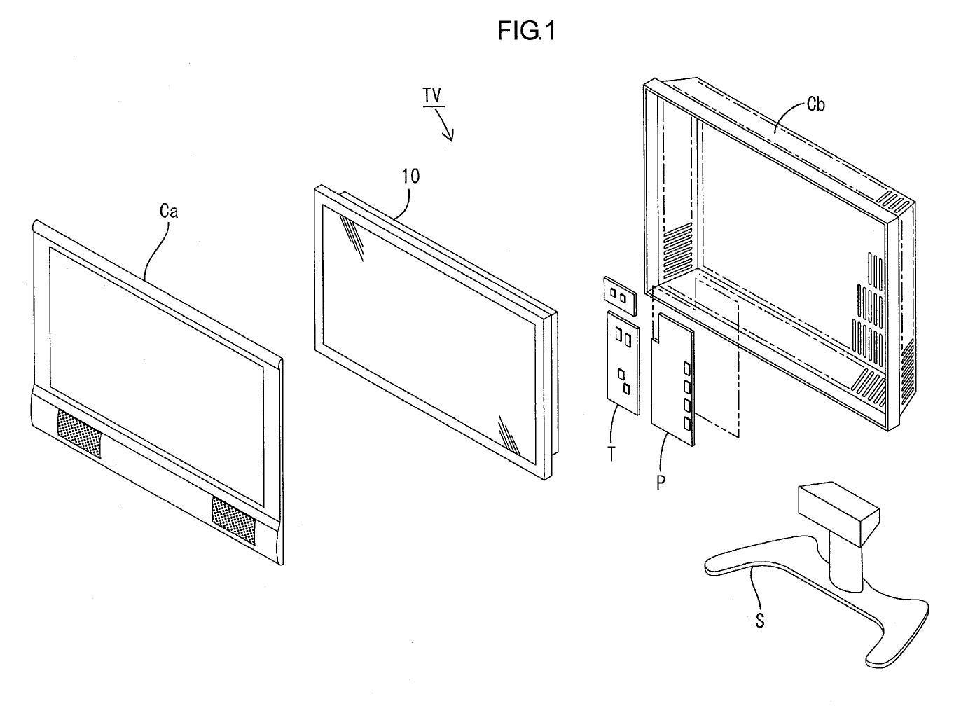

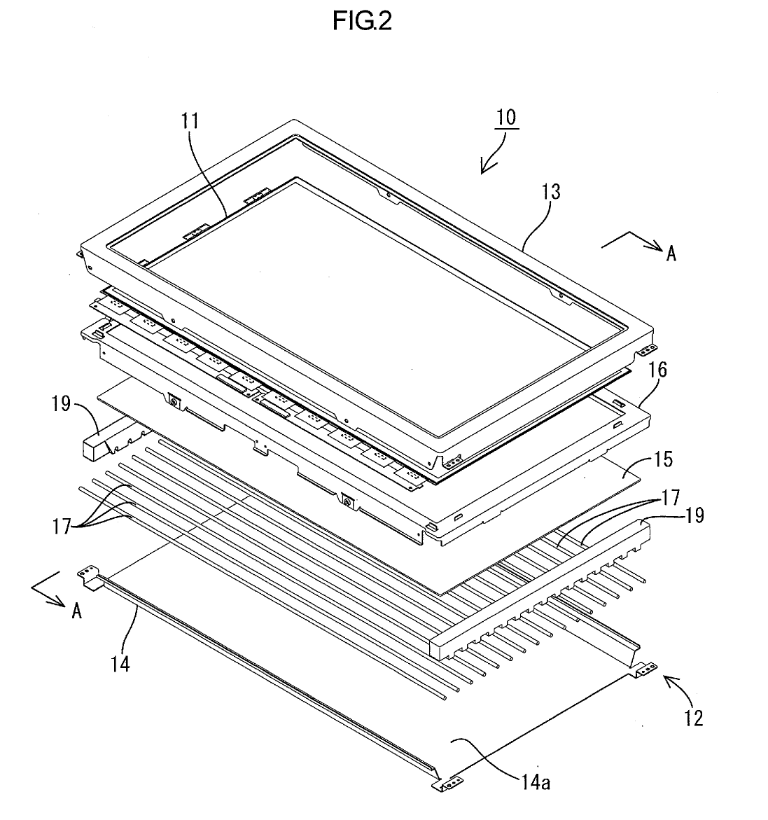

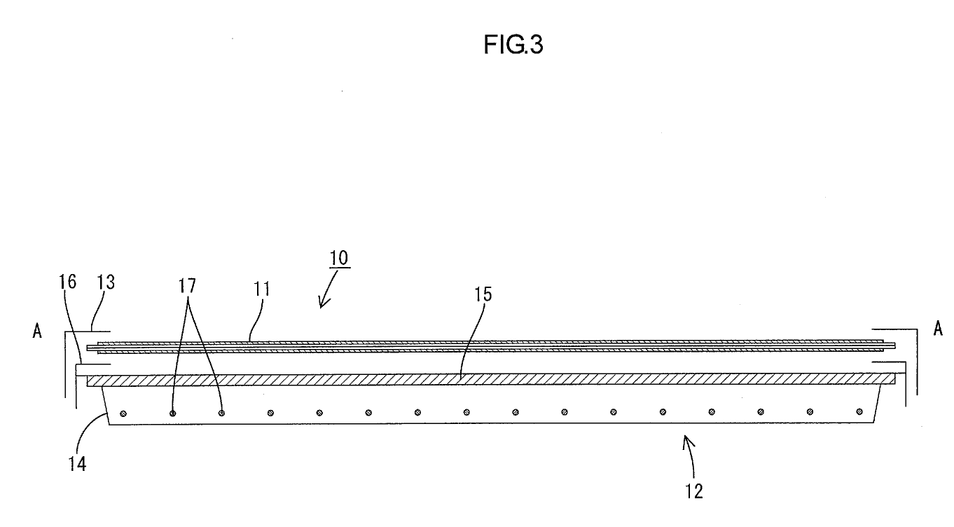

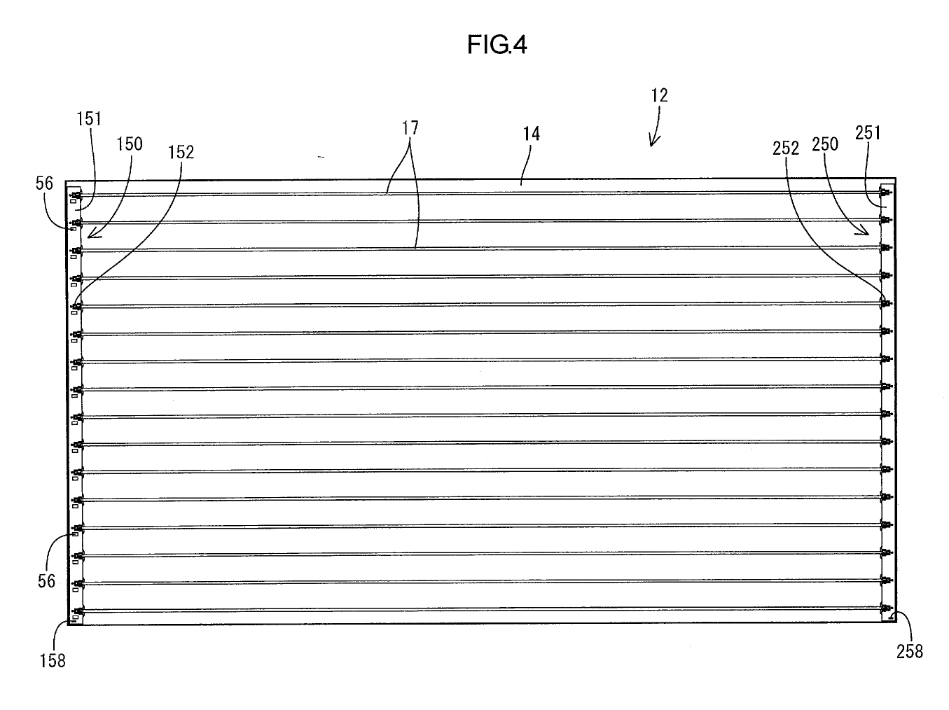

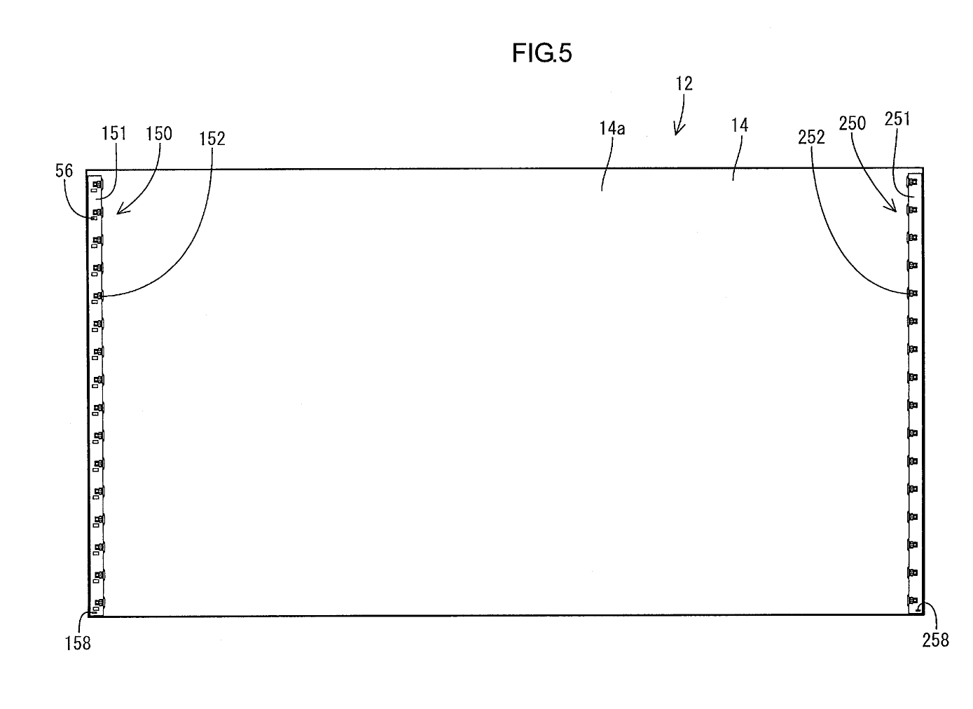

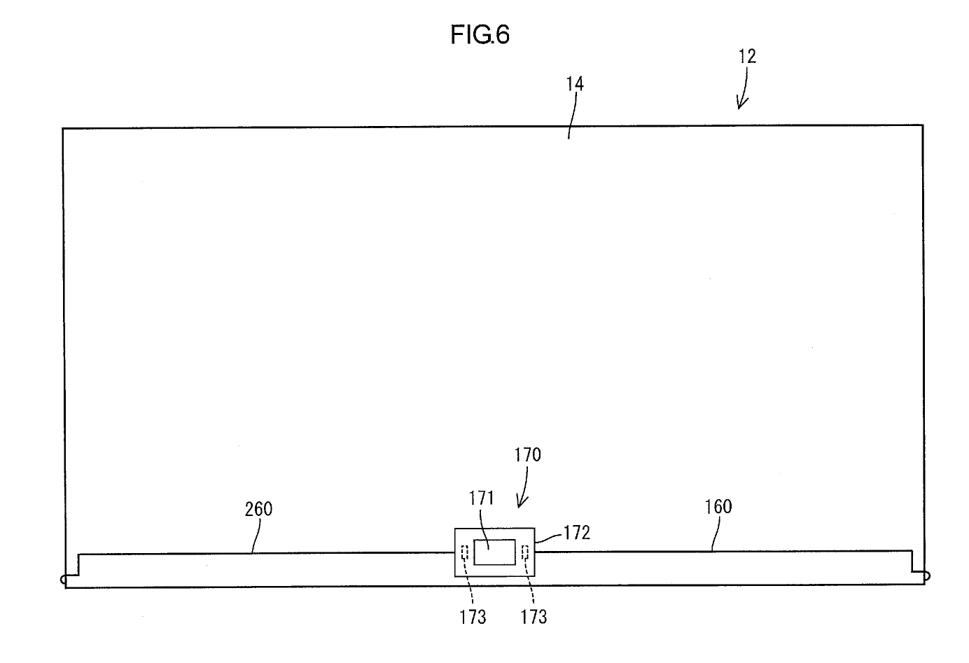

FIG. 1 is an exploded perspective view illustrating a general construction of a television receiver of the present embodiment. FIG. 2 is an exploded perspective view illustrating a general construction of a liquid crystal display device (display device) 10 included in the television receiver. FIG. 3 is a cross-sectional view of FIG. 2 along the line A-A. FIG. 4 is a front view illustrating a main construction of a backlight device 12 included in the liquid crystal display device 10. FIG. 5 is a front view illustrating a main construction of the backlight device 12 without the cold cathode tubes. FIG. 6 is a rear view illustrating a main construction of the backlight device 12.

As illustrated in FIG. 1, the television receiver TV of the present embodiment includes a liquid crystal display device (display device) 10, front and rear cabinets Ca, Cb that house the liquid crystal display device 10 therebetween, a power source P that is provided separately from a power supply board 170 (a power source) that will be described later, a tuner T and a stand S. An overall view of the liquid crystal display device 10 is a landscape rectangular. As illustrated in FIG. 2, it includes a liquid crystal panel 11, which is a display panel having a rectangular plan view, and a backlight device (lighting device) 12, which is an external light source. They are integrally held by a bezel 13 and the like.

The liquid crystal panel 11 has a known configuration such that liquid crystal (a liquid crystal layer) that changes its optical characteristics according to applied voltages is sealed between a transparent TFT substrate and a transparent CF substrate. A number of source lines and gate lines are formed on an inner surface of the TFT substrate. The source lines extend in a longitudinal direction and the gate lines extend a transverse direction so as to form a grid pattern. Color filters including red (R), green (G) and blue (B) coloring portions that are arranged in a matrix are provided on the CF substrate. Polarizing plates are attached to surfaces of those substrates on sides opposite from the liquid crystal side.

The backlight device 12 is a so-called direct backlight device in which a light source is arranged directly below the liquid crystal panel 11. The backlight device 12 includes a chassis 14, a reflective sheet 14a, an optical member 15, a frame 16, cold cathode tubes 17 and lamp holders 19. The chassis 14 has an opening on the front (light output side). The reflective sheet 14a is placed inside the chassis 14. The optical members 15 are arranged near the opening of the chassis 14. The frame 16 holds the optical member 15. The cold cathode tubes 17 are installed in the chassis 14. The lamp holders 19 shield ends of the cold cathode tubes 17 from light and have light reflectivity.

The optical member 15 has a function that converts linear light emitted from each cold cathode tube 17 (discharge tube), which is a linear light source, to planar light, and directs the planar light toward an effective display area of the liquid crystal panel (directivity).

The chassis 14 is formed of metal and in a substantially box-shape having a rectangular plan view and an opening on the front side (light output side). The reflective sheet 14a is made of synthetic resin and a white material having good reflectivity. It is disposed in the chassis 14 so as to cover an entire inner surface of the chassis 14. The reflective sheet 14a directs most of rays of light emitted from each cold cathode tube 17 toward an opening side of the chassis 14.

As illustrated in FIGS. 4 and 5, a first light source holding member 150 and a second light source holding member 250 are provided on a front-surface side (an inner surface side) of the chassis 14. The first light source holding member 150 includes clip terminals (connecting terminals) 152 that hold one ends of the cold cathode tubes 17 and supply driving power to the cold cathode tubes 17. The second light source holding member 250 includes clip terminals (connecting terminals) 252 that hold another ends of the cold cathode tubes 17 and supply driving power to the cold cathode tubes 17. The cold cathode tubes 17 are arranged parallel to each other on the front-surface side of the chassis with held by the first light source holding member 150 and the second light source holding member 250.

As illustrated in FIG. 6, a power supply board 170 (a power source) including an inverter circuit for supplying driving power to the cold cathode tubes 17 is arranged on a rear-surface side of the chassis 14. Accordingly, the cold cathode tubes 17 are driven in parallel. A two-side driving system is used in the present embodiment. In the two-side driving system, the power supply board 170 is provided on the rear-surface side of the chassis 14 and power is supplied from the power source to two ends of each cold cathode tube 17. In the present embodiment, the driving power supplied to one end of each cold cathode tube 17 and the driving power supplied to another end of each cold cathode tube 17 are in opposite phases. The driving power is supplied to the one end and the other end of each cold cathode tube 17 so that the potential at the one end and at the other end is higher than the potential at the chassis 14 (the grand potential). The capacitors 56 are connected to the one ends of the cold cathode tubes 17 that are arranged parallel to each other, that are the first light source holding member 150 side of the cold cathode tubes 17. The capacitors 56 are provided between the power supply board 170 and each of the cold cathode tubes 17 and unifies a current amount of the driving power that is supplied to each of the cold cathode tubes 17. In other words, the capacitors are not provided on the second light source holding member 250 side and the driving power is supplied from the power supply board 170 to each of the cold cathode tubes 17 without the capacitors. Hereinafter, a configuration related to supply of the driving power to the cold cathode tubes 17 and an operation thereof will be explained.

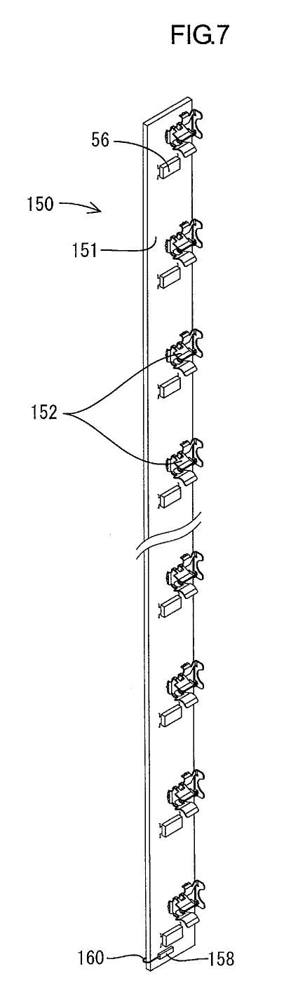

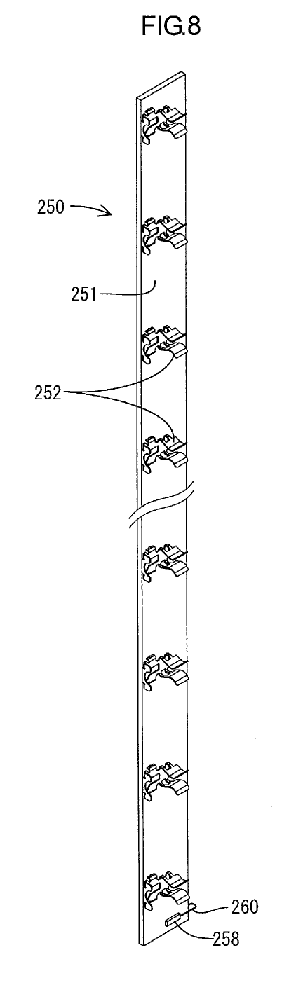

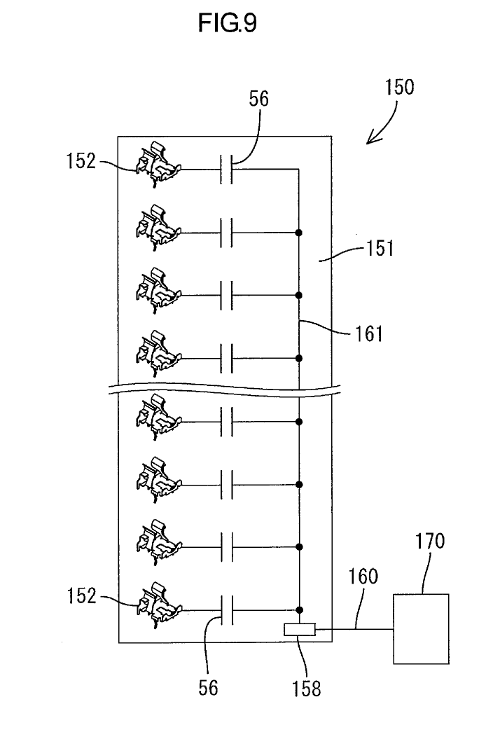

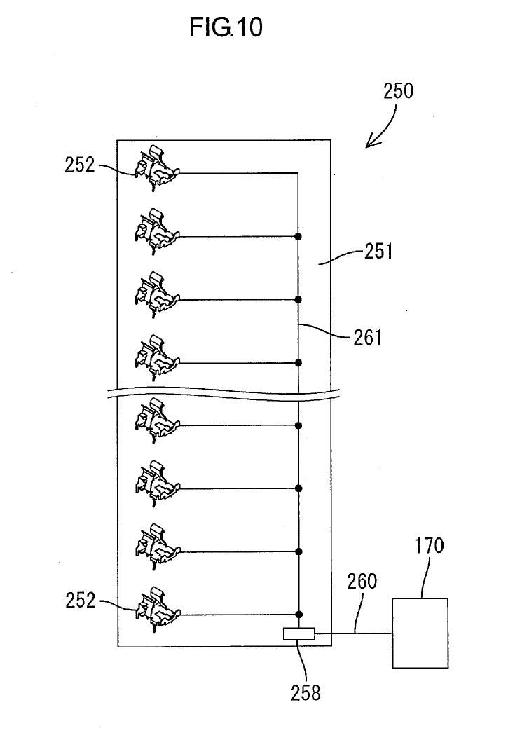

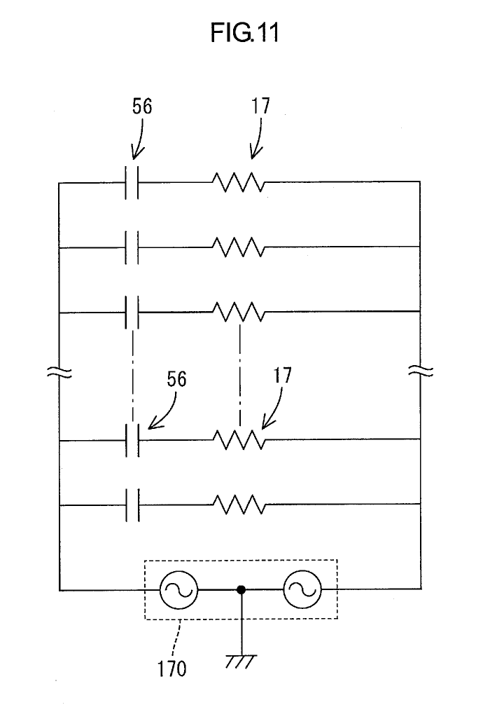

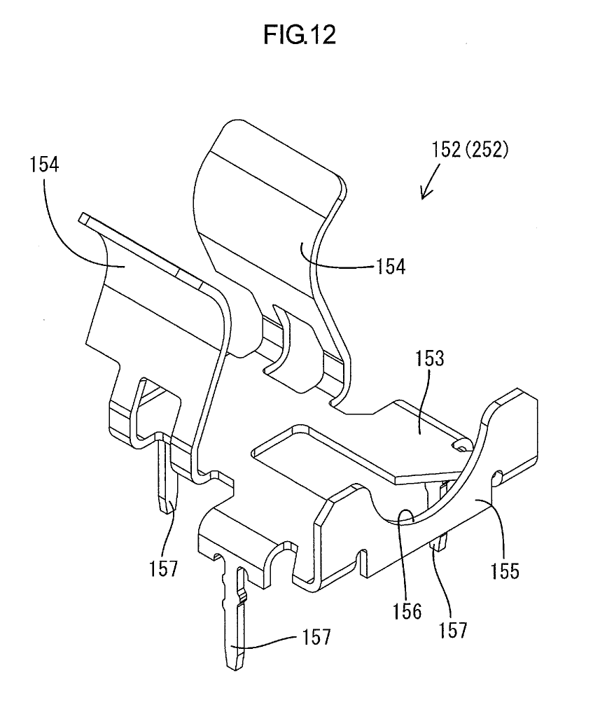

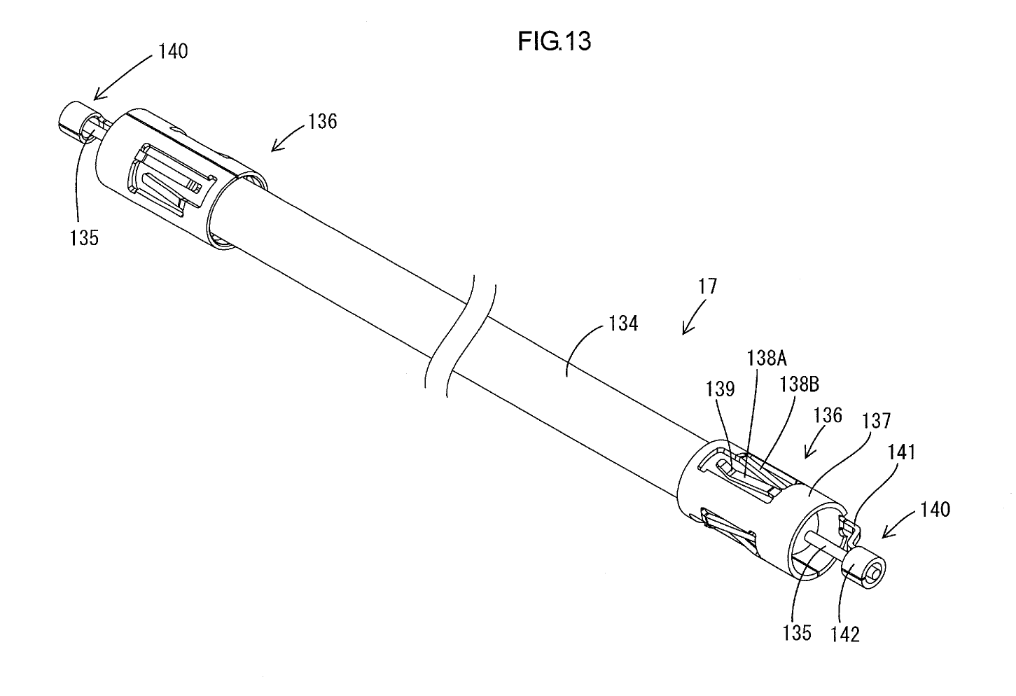

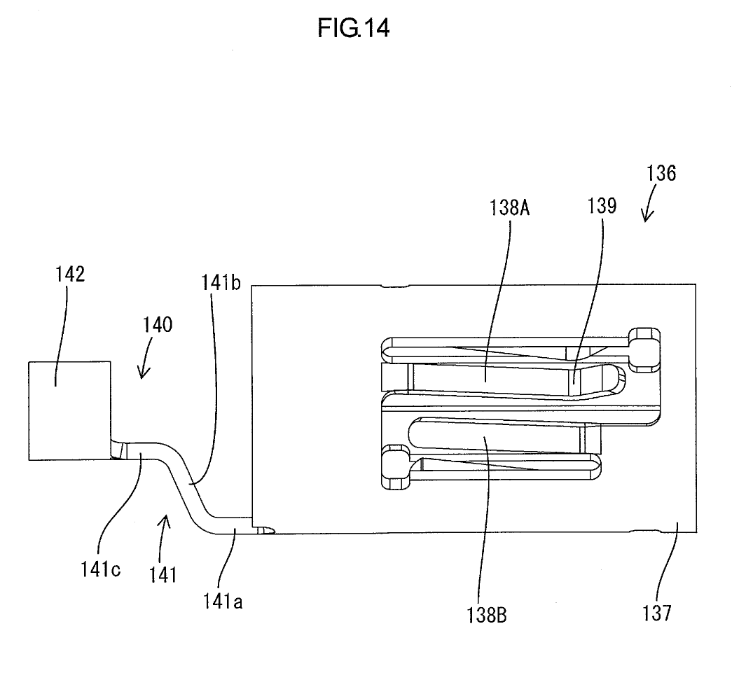

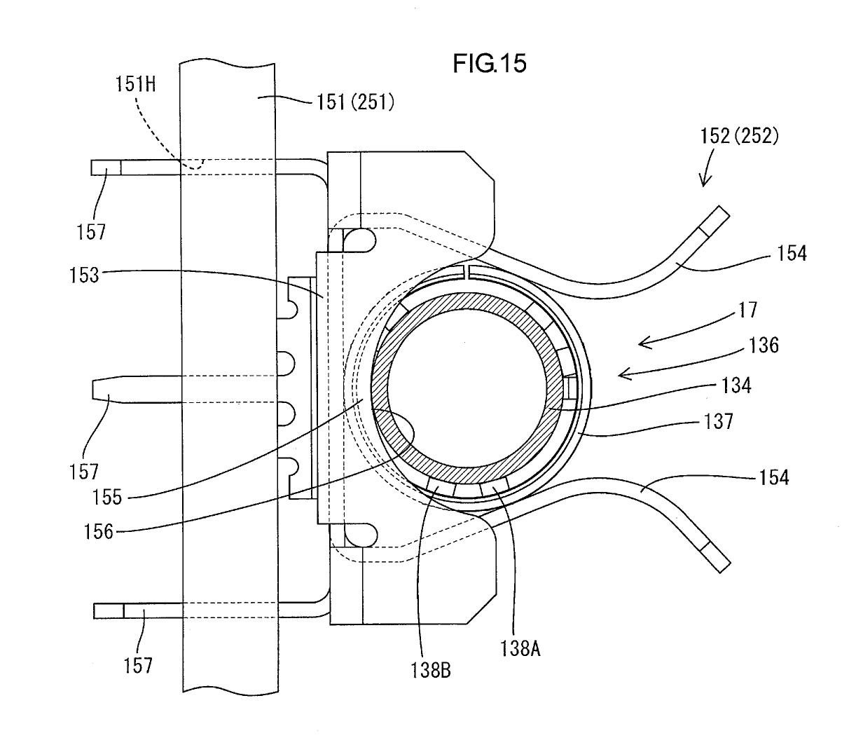

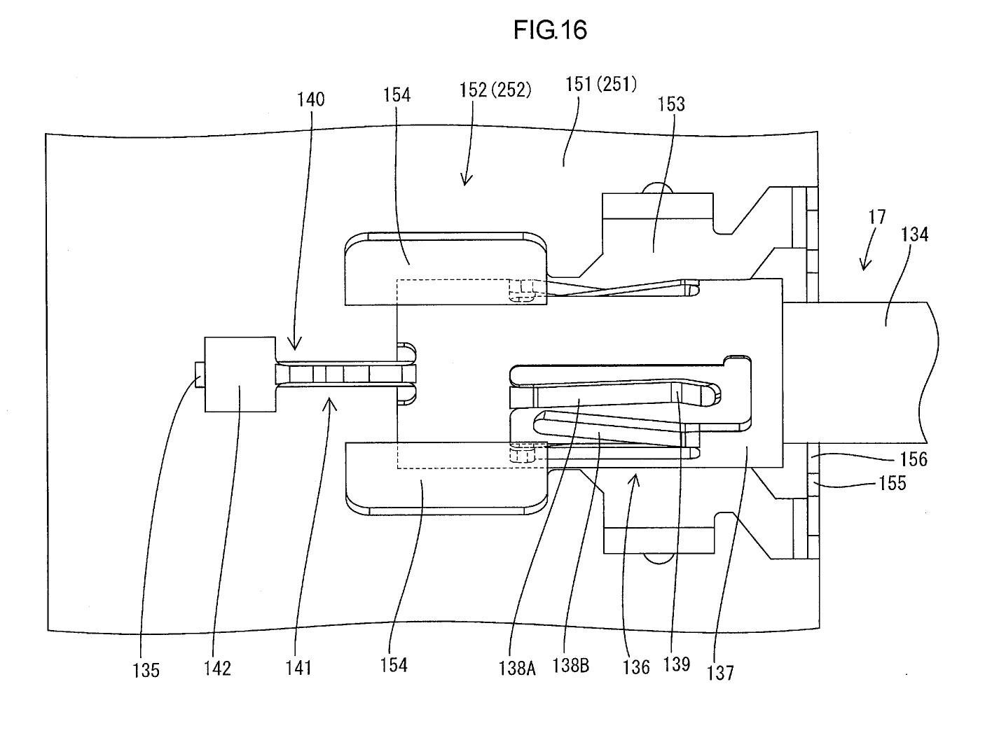

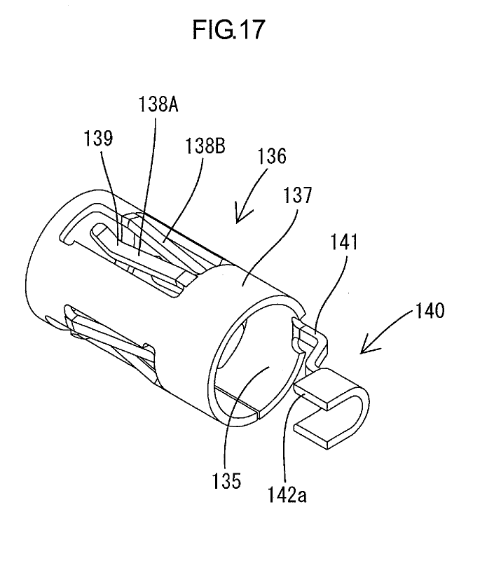

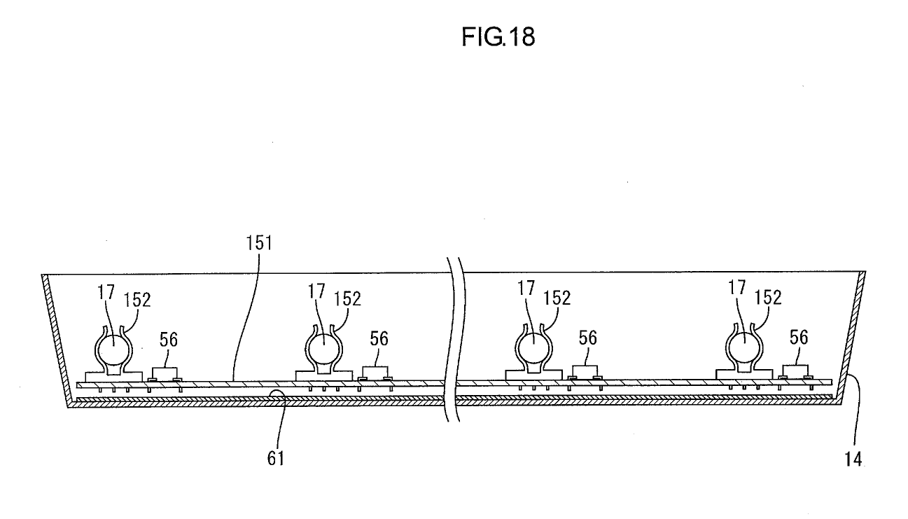

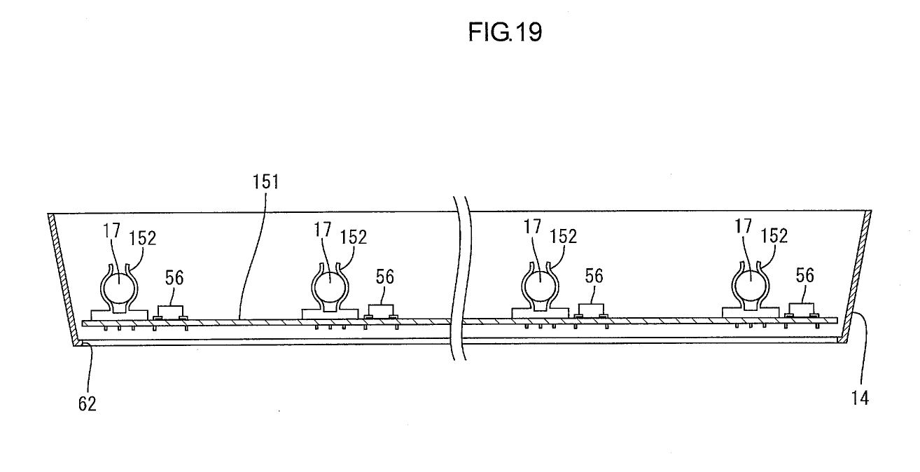

FIG. 7 is a perspective view illustrating a construction of a first light source holding member 150. FIG. 8 is a perspective view illustrating a construction of a second light source holding member 250. FIG. 9 is an explanatory view illustrating a mechanism for supplying driving power to the cold cathode tubes 17 on the first light source holding member 150 side. FIG. 10 is an explanatory view illustrating a mechanism for supplying driving power to the cold cathode tubes 17 on the second light source holding member 250 side. FIG. 11 is an explanatory view illustrating a circuit configuration related to power supply from the power supply board 170 to the cold cathode tubes 17. FIG. 12 is a perspective view illustrating a construction of the clip terminal 152 (252). FIG. 13 is a perspective view illustrating a construction of the cold cathode tube 17. FIG. 14 is a plan view illustrating a construction of a ferrule 136 connected to the cold cathode tube 17. FIG. 15 is a front view illustrating the clip terminal 152 (252) holding the cold cathode tube 17. FIG. 16 is a plan view illustrating the clip terminal 152 (252) holding the cold cathode tube 17. FIG. 17 is a perspective view illustrating a ferrule 136 of one modification. FIG. 18 is an explanatory view illustrating a mechanism that disconnects the chassis 14 and the clip terminal 152. FIG. 19 is an explanatory view illustrating a mechanism that disconnects the chassis 14 and the clip terminal 152.

[Cold Cathode Tubes 17]

First, the construction of each cold cathode tube 17 will be explained.

As illustrated in FIG. 13, the cold cathode tube 17 is constructed of a glass tube 134, outer leads 135 and ferrules 136. The glass tube 134 is a linear glass tube having a longitudinal overall shape and a circular cross section. The outer leads 135 are made of metal (e.g., nickel or cobalt containing metal) and formed in a longitudinal shape having a circular cross section with the same center as the glass tube 134. They extend linearly from both ends of the glass tube 134. The ferrules 136 are mounted to the respective ends of the glass tube 134. Mercury is sealed inside the glass tube 134. The ends of the glass tube 134 are heated and melted so as to form a substantially dome shape. The outer leads 135 penetrate through the domes.

As illustrated in FIG. 14, each ferrule 136 is a single part formed in that shape by bending or hammering a metal plate (e.g., a stainless plate) punched out in a predetermined shape. The ferrule 136 includes one body 137 and a conductive piece 140. The body 137 has a cylindrical overall shape with the same center as the glass tube 134. An inner diameter of the body 137 is defined slightly larger than an outer diameter of the glass tube 134.

The body 137 has three pairs of elastic holding pieces 138A, 138B formed at an equal angle pitch in a circumferential direction by cutting parts of the body 137 in slits.

The first elastic holding piece 138A among a pair of the elastic holding pieces 138A, 138B has a cantilever-like shape that extends generally toward the rear (specifically, toward an inner direction slightly diagonal to the radial direction). It is elastically flexible in the radial direction with its base portion (front end) as a pivot point. An extending end (rear end) of the first elastic holding piece 138A has a bending portion 139 where the piece is bent at an angle outward in a radial direction. A surface of the bending portion 139 on a crest side (i.e., a surface facing inward) is a contact point that will come in contact with a periphery of the glass tube 134. An imaginary circle that connects the contact points of three of the first elastic holding pieces 138A has the same center as the body 137. A diameter of the imaginary circle is smaller than the outer diameter of the glass tube 134 when the first elastic holding pieces 138A are in a free state without any elastic deflection.

The second elastic holding piece 138B among a pair of the elastic holding pieces 138A, 138B is provided adjacent to the first elastic holding piece 138A in the circumferential direction. It has a cantilever-like shape that extends generally toward the front (specifically, toward an inner direction slightly diagonal to the radial direction), which is an apposite direction from the extending direction of the first elastic holding piece 138A. It is elastically flexible in the radial direction with its base portion (rear end) as a pivot point. An extending end of the second elastic holding piece 138B is a contact point that will come into contact with a periphery of the glass tube 134. An imaginary circle that connects the contact points of three of the second elastic holding pieces 138B has the same center as the body 137. A diameter of the imaginary circle is smaller than the outer diameter of the glass tube 134 when the second elastic holding pieces 138B are in a free state without any elastic deflection.

The body 137 has a cantilever-like conductive piece 140 that extends from the end of the body 137 forward. Each conductive piece 140 has a stem portion 141 that continues from the front end of the body 137 and a drum-shaped portion 142 that extends from a front end (extending end) of the stem portion 141 further forward. The stem portion 141 has a base section 141a, a middle section 141b and an end section 141c. The base section 141a extends from the body 137 along an axis of the body 137 such that the surfaces thereof and the body 137 are on the same flat plane. The middle section 141b extends from an extending end of the base section 141a toward the axis of the body 137, that is, inward in the radial direction of the body 137. The end section 141c extends from an extending end of the middle section 141b along the axis of the body 137. The drum-shaped portion 142 is connected with the extending end of the end section 141c. A width of the stem portion 141 is sufficiently smaller than a length of the stem portion 141. This allows the stem portion 141 to elastically deform in the radial direction of the body 137 and in a direction that crosses the radial direction (a direction that crosses the longitudinal direction of the stem portion 141). It also allows the stem portion 141 to twist around an axis, which is the stem portion 141 itself. The drum-shaped portion 142 is formed in a drum-like shape by bending a portion that extends from the extending end of the stem portion 141 in the lateral direction so as to have an axis substantially in the same position as the axis of the body 137. The drum-shaped portion 142 can be displaced in a helical direction and a radial direction of the ferrule 136 with elastic flexibility of the stem portion 141.

[First Light Source Holding Member 150]

Next, a construction of the first light source holding member 150 will be explained.

The first light source holding member 150 holds the ends of the cold cathode tubes 17 to mount the cold cathode tubes 17 to the chassis 14. The first light source holding member 150 includes an elongated support plate (a support member) 151, a number of clip terminals 152 mounted on a front surface of the support plate 151, and a number of ballast capacitors 56 that unify a current amount of driving power supplied to each clip terminal 152.

The support plate 151 is formed of a base plate made of a conductive material such as metal. The support plate 151 is arranged on one end of the chassis 14, in this embodiment, on same one end side of each of the cold cathode tubes 17 that are arranged parallel to each other. The support plate 151 is provided along the end portion of the chassis 14. The support plate 151 has three mounting through holes 151H (see FIG. 15) for each clip terminal 152 and the clip terminal 152 is mounted to the holding holes 151H.

As illustrated in FIG. 12, each clip terminal 152 is formed by bending a metal plate (e.g., nickel silver alloy) punched in a predetermined shape. It has a base 153, a pair of elastically pressing pieces 154 and a stopper 155. Each of the elastically pressing pieces 154 extends from an upper edge or a lower edge of the base 153 toward the front. They are formed vertically symmetric. The stopper 155 extends from one side of the base 153 toward the front.

The elastically pressing pieces 154 are formed in an opposite end area from the stopper 155 and in a form that curves toward each other. The elastically pressing pieces 154 may be elastically deflected such that a gap between them is widened. The minimum gap between the pair of elastically pressing pieces 154 is smaller than the outer diameter of the glass tube 134 of the cold cathode tube 17 when the elastically pressing pieces 154 are not elastically deflected.

The stopper 155 extends from the base 153 so as to stand at right with respect to the axis of the cold cathode tube 17. A part of a side of the stopper 155 is cut in a substantially semi-circular shape and a blank 156 is formed. Upper and lower portions of the stopper 155 around the blank 156 extending from the base 153 are small and thus the amount of metal material required for the clip terminal 152 is small.

Furthermore, three legs 157 are formed integrally with the base 153. Two of them are located between the elastically pressing pieces 154 and the stopper 155, and extend from the upper and lower edges of the base 153 toward an opposite side (rear side) from the elastically pressing piece 154 and the stopper 155. The other one is located at an intermediate position between the elastically pressing pieces 154 in an opposite end area from the stopper 155, and extends from the base 153 toward an opposite side (rear side) from the elastically pressing piece 154 and the stopper 155.

The clip terminal 152 is not housed by a housing made of synthetic resin, and directly fixed to the base 151 by soldering and the like without any covering with the legs 157 passed through the mounting holes 151H.

Each ballast capacitor 56 is a balancing component and one ballast capacitor 56 is provided for each clip terminal 152. The ballast capacitors 56 are arranged on the base 151 such that each ballast capacitor 56 is connected to the corresponding clip terminal 152 in series (see FIG. 9).

The ballast capacitors 56 are connected in parallel to the power supply board (the power source) 170. More specifically, as illustrated in FIGS. 9 and 11, each ballast capacitor 56 is connected to a common line 161 provided on a rear-surface side of the base 151. This connects each ballast capacitor 56 to a connector 158 for power source connection (power source connecting section) that is provided at an end of the base 151. The connector 158 for power source connection is connected to a power supply line 160 from the power supply board 170.

[Second Light Source Holding Member 250]

Next, a construction of the second light source holding member 250 will be explained.

The second light source holding member 250 holds the ends of the cold cathode tubes 17 to mount the cold cathode tubes 17 to the chassis 14. The second light source holding member 250 includes an elongated support plate (a support member) 251, and a number of clip terminals 252 mounted on a front surface of the support plate 251. Unlike the first light source holding member 150, the second light source holding member 250 includes no ballast capacitor.

The support plate 251 is formed of a base plate made of a conductive material such as metal. The support plate 251 is arranged on one end of the chassis 14, in this embodiment, on another end side (on an end that is opposite from the one on which the first light source holding member 150 is arranged) of each of the cold cathode tubes 17 that are arranged parallel to each other. The support plate 251 is provided along the end portion of the chassis 14. The support plate 251 has three mounting through holes 151H (see FIG. 15) for each clip terminal 252 and the clip terminal 252 is mounted to the holding holes 151H.

As illustrated in FIG. 12, each clip terminal 252 is formed by bending a metal plate (e.g., nickel silver alloy) punched in a predetermined shape. It has a base 153, a pair of elastically pressing pieces 154 and a stopper 155. Each of the elastically pressing pieces 154 extends from an upper edge or a lower edge of the base 153 toward the front. They are formed vertically symmetric. The stopper 155 extends from one side of the base 153 toward the front.

The elastically pressing pieces 154 are formed in an opposite end area from the stopper 155 and in a form that curves toward each other. The elastically pressing pieces 154 may be elastically deflected such that a gap between them is widened. The minimum gap between the pair of elastically pressing pieces 154 is smaller than the outer diameter of the glass tube 134 of the cold cathode tube 17 when the elastically pressing pieces 154 are in a state without any elastic deflection.

The stopper 155 extends from the base 153 so as to stand at right with respect to the axis of the cold cathode tube 17. A part of a side of the stopper 155 is cut in a substantially semi-circular shape and a blank 156 is formed. Upper and lower portions of the stopper 155 around the blank 156 extending from the base 153 are small and thus the amount of metal material required for the clip terminal 152 is small.

Furthermore, three legs 157 are formed integrally with the base 153. Two of them are located between the elastically pressing pieces 154 and the stopper 155, and extend from the upper and lower edges of the base 153 toward an opposite side (rear side) from the elastically pressing piece 154 and the stopper 155. The other one is located at an intermediate position between the elastically pressing pieces 154 in an opposite end area from the stopper 155, and extends from the base 153 toward an opposite side (rear side) from the elastically pressing piece 154 and the stopper 155.

The clip terminal 252 is not housed by a housing made of synthetic resin, and directly fixed to the base 251 by soldering and the like without any covering with the legs 157 passed through the mounting holes 151H.

The clip terminals 252 are arranged on the base 251 in parallel to each other corresponding to the arrangement of the cold cathode tubes 17. The clip terminals 252 are connected in parallel to the power supply board (power source) 170.

More specifically, as illustrated in FIGS. 10 and 11, each clip terminal 252 is connected to a common line 261 provided on a rear-surface side of the base 251. This connects each clip terminal 252 to a connector 258 for power source connection (power source connecting section) that is provided at an end of the base 251. The connector 258 for power source connection is connected to a power supply line 260 from the power supply board 170.

[Power supply board 170]

As illustrate in FIG. 6, the power supply board 170 includes a circuit board 172 having circuits on the rear surface (on the opposite side from the chassis 14), electronic components 171 mounted on the rear surface of the circuit board 172, and an on-board connector 173 mounted on a surface of the circuit board 172 close to the chassis 14. The electronic components 171 include a transformer, and the circuit board 172 is configured as an inverter circuit board that generates a high frequency voltage.

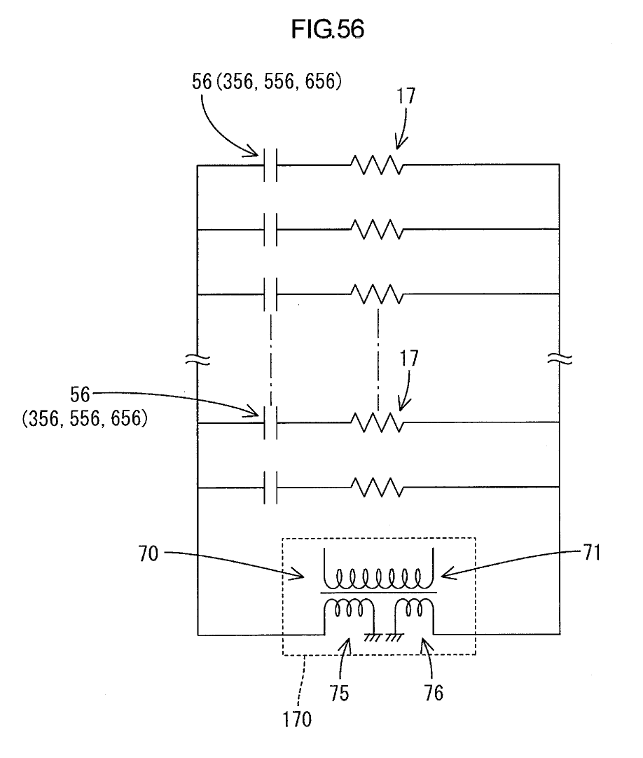

The on-board connector 173 is connected to each connector 158, 258 for power source connection that is arranged on the base 151, 251 of the chassis via the power supply line 160, 360. In the present embodiment, the driving power supplied to the first light source holding member 150 and the driving power supplied to the second light source holding member 250 are in opposite phases. The driving power is supplied to the first light source holding member 150 and the second light source holding member 250 so that the potential at the first light source holding member 150 and the second light source holding member 250 is higher than that of the chassis 14. As illustrated in FIG. 56, one transformer 70 outputs driving power in opposite phases. The transformer 70 includes one primary coil 71, a first secondary coil 75 and a second secondary coil 76. The first secondary coil 75 has a relatively great number of coil turns and the second secondary coil 76 has a relatively small number of coil turns. The secondary coils 75, 76 are arranged for one primary coil 71.

Accordingly, driving power of higher voltage is supplied to the one end side of the cold cathode tubes 17 to which the capacitors 56 are connected (the side close to the first light source holding member 150) than another end side of the cold cathode tube 17 to which no capacitor 56 is connected (the side close to the second light source holding member 250). The power supply board 170 is assembled and fixed to the chassis 14 via screws for example.

[Attaching Cold Cathode Tubes 17 to Clip Terminals 152 (252)]

When attaching the cold cathode tube 17 to the clip terminal 152 (252), holding it horizontally straight, bring it close to the front of the chassis 14, and push the ends of the glass tube 134 and the ferrules 136 in the gaps between the respective pairs of elastic pressing pieces 154 that face each other from the front side (see FIGS. 15 and 16). The elastically pressing pieces 154 are elastically deflected by the bodies 137 of the ferrules 136 to widen the gaps. After each body 137 has passed the minimum gap areas between the pair of elastically pressing pieces 154, the elastically pressing pieces 154 draw the body 137 toward the base 153 side with the elastic resilience thereof. As a result, the body 137 is brought into contact with the base 153 and the attachment of the cold cathode tube 17 is completed.

The attached cold cathode tube 17 is held by the clip terminal 152 (252) at the two ends thereof. The elastically pressing pieces 154 elastically contact the outer walls of the bodies 137 of the ferrules 136 and thus the outer leads 135 are connected to the clip terminals 152 (252) via the ferrules 136 with conductivity. Further, the glass tube 134 is pressed against the stopper 155 and held in the blanks 156 by the elastic resilience of the elastically pressing pieces 154. Parts of the bodies 137 overlap the stoppers 155 when viewed in the axial direction of the cold cathode tube 17. Namely, parts of the edges of the bodies 137 on the sides opposite from the conductive pieces 140 are positioned closely to the stoppers 155 in the axial direction and face the stoppers 155.

According to the television receiver TV of the present embodiment, the liquid crystal display device 10 includes the backlight device 12 having the configuration of the present invention. Therefore, it provides the following operation effects.

Since the ballast capacitors 56 are connected between the clip terminals 152 and the power supply board 170 to output the constant current for the driving power supplied to each clip terminal 152, the current supplied to each cold cathode tube 17 is uniform (constant). The cold cathode tubes 17 are driven in parallel with the common power source 170. The ballast capacitors 56 are arranged on only one side of the cold cathode tubes 17, that is on only the side close to the first light source holding member 150. This achieves cost reduction compared to a configuration in which the capacitors are arranged on two sides of the cold cathode tubes 17.

The power supply board 170 includes one transformer 70 and the transformer 70 outputs driving power to the first light source holding member 150 and the second light source holding member 250. The driving power output to the first light source holding member 150 and the second light source holding member 250 are in opposite phases. This achieves cost reduction compared to a case in which separate transformers are provided to supply driving power in opposite phases. Especially, in the present embodiment, when driving power is supplied to two ends of the cold cathode tube 17, driving power of higher voltage is supplied to the one end side of the cold cathode tubes 17 to which the ballast capacitors 56 are connected than the other end side of the cold cathode tube 17 to which no capacitor is connected. A position of an imaginary ground in a longitudinal direction of the cold cathode tube 17 is shifted close to a center. This improves bilateral symmetric brightness.

In the present embodiment, the clip terminals 152 (252) having a connection terminal function are arranged on the base 151 (251) that supports the ends of the cold cathode tubes 17. This enables positioning of the cold cathode tubes 17 and current supply to the cold cathode tubes 17 simultaneously with a simple configuration. Especially, each of the bases 151, 251, that are the light source holding members 150, 250, is arranged along each end-side of the cold cathode tubes 17 so as to support each end of the cold cathode tubes 17 that are arranged parallel to each other. This enables positioning of the cold cathode tubes 17 by the light source holding member 150 (250) and current supply to the cold cathode tubes 17 simultaneously on the side where the ballast capacitors 56 are arranged and on the side where no ballast capacitors 56 are arranged. The ballast capacitors 56 are also arranged on the base 151. This simplifies the configuration for positioning the cold cathode tubes 17 and supplying current to the discharge tubes. This achieves further cost reduction.

Each cold cathode tube 17 includes the ferrule 136 that can be electrically connected to the clip terminal 152 (252). This enables attaching of the cold cathode tube 17 to the clip terminal 152 (252) and electrical connection between the ferrule 136 and the clip terminal 152 (252) simultaneously. This contributes to significant cost reduction in the manufacturing process with a simple configuration. Especially, each cold cathode tube 17 includes the linear glass tube 134, the outer leads 135 extending linearly from the either end of the glass tube 134 with a same center as the glass tube 134, and the ferrules 136 mounted to either end of the glass tube 134 and electrically connected to the outer leads 135, and the ferrule 136 is electrically connected to the corresponding clip terminal 152 (252). This simplifies the attachment operation and ensures electrical connection.

The ferrules may be configured as illustrated in FIG. 17. The drum-shaped portions 142 of the ferrules 136 illustrated in FIGS. 13 and 14 may be modified to connecting portions 142a having a U-shape. When the glass tube 134 is fitted in the ferrules 136, the U-shaped connecting portions 142a are bent along the outer leads 135 and thus the outer leads 135 can be electrically connected with the connecting portions 142a. This modification, that is, the connecting portions 142 are formed in a U-shape by bending, provides better electrical connection between the ferrules and the outer leads 135.

To obtain insulation between the chassis 14 and the base 151, an insulation substrate (insulation member) 61 may be provided between the chassis 14 and the base 151 as illustrated in FIG. 18. As illustrated in FIG. 19, an opening 62 may be provided in an area of the chassis 14 that overlaps the base 151. Alternatively, the chassis 14 may be made of resin material. To obtain insulation between the chassis 14 and the base 251, the insulation member 61 and the opening 62 may be formed for the base 251 like the base 151.

### Second Embodiment

A second embodiment of the present invention will be explained. In the second embodiment, a first light source holding member (a first relay member) 350 is provided for the first light source holding member 150 of the first embodiment and a second light source holding member (a second relay member) 450 is provided for the second light source holding member 250. Other components are same as those in the first embodiment and are indicated by the same symbols and may not be explained.

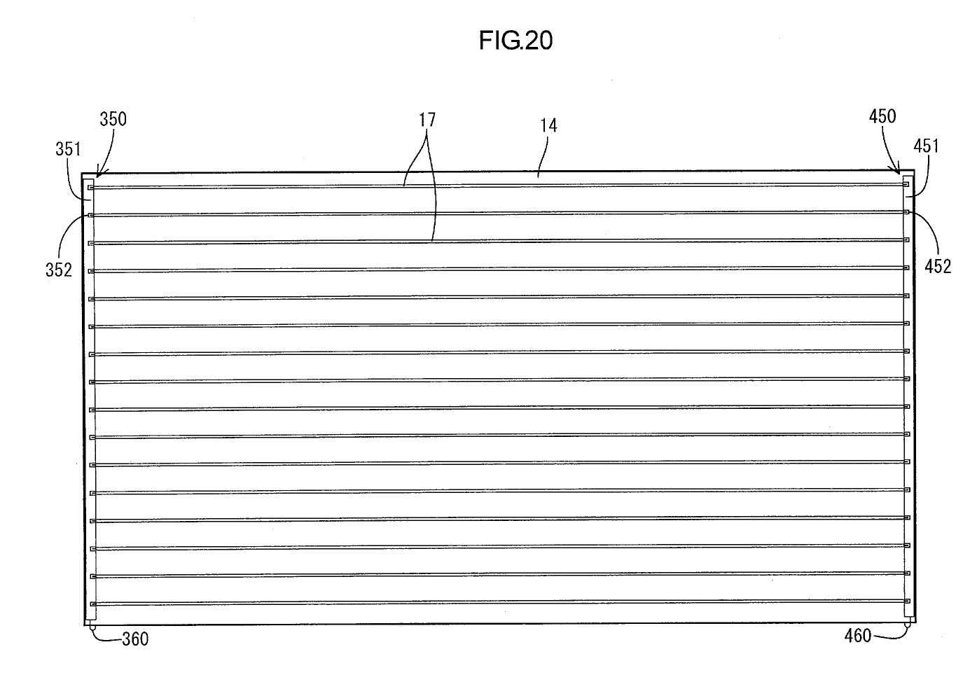

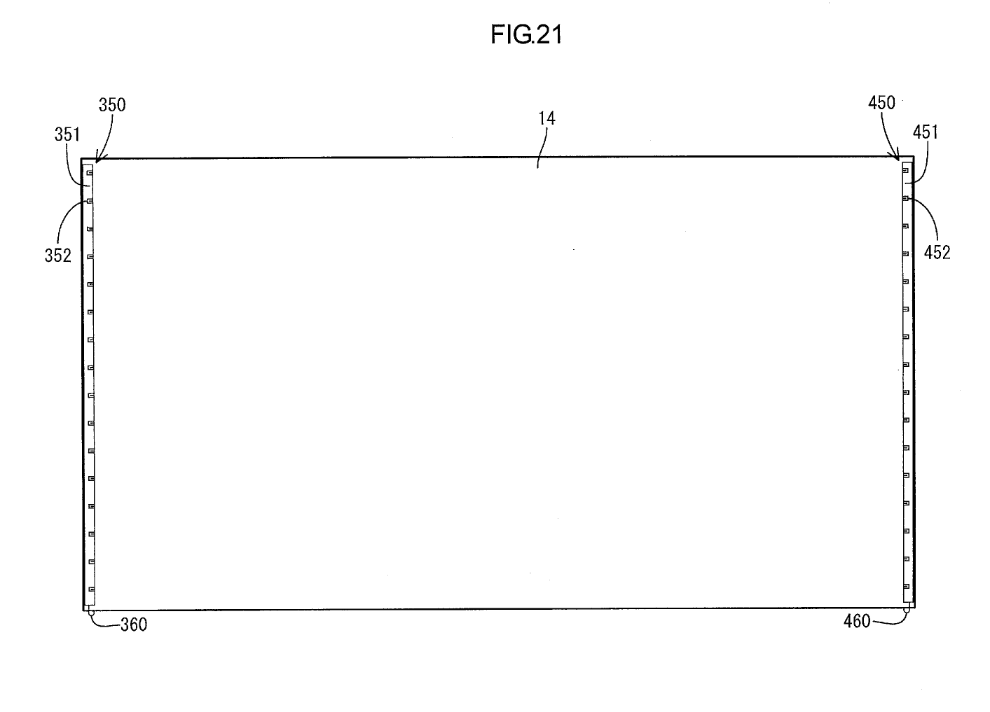

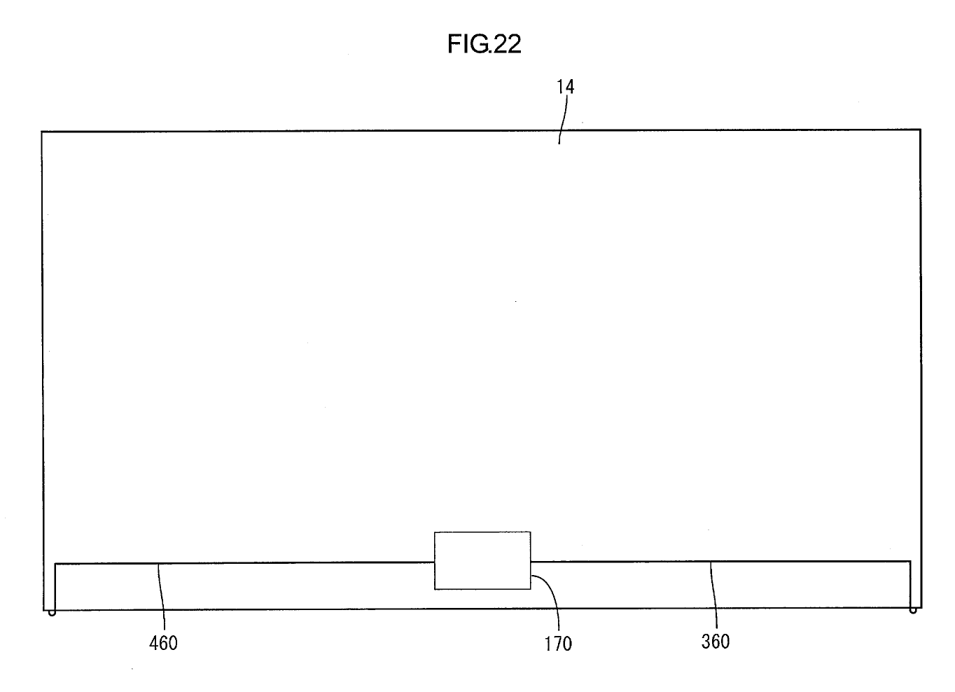

FIG. 20 is a front view illustrating a main construction of a backlight device included in a liquid crystal display device of a television receiver according to a second embodiment. FIG. 21 is a front view illustrating the main construction of the backlight device. FIG. 22 is a rear view illustrating the main construction of the backlight device. In the second embodiment also, the cold cathode tubes 17 are arranged parallel to each other on a front-surface side of the chassis 13, and the power supply board 170 is arranged on a rear-side surface of the chassis 14. The power supply board 170 supplies driving power for driving the cold cathode tubes 17 in parallel. The driving power supplied to one-end side of the cold cathode tubes 17 and the driving power supplied to another-end side of the cold cathode tubes 17 are in opposite phases.

As illustrated in FIGS. 20 and 21, relay members 350, 450 for relaying (connecting with electric conductivity) driving power supplied from the power supply board 170 to the cold cathode tubes 17 are disposed on a front-side surface of the chassis 14. Each of the relay members 350, 450 includes a base 351, 451 that is made of an insulation substrate and relay bodies 352, 452 which correspond one-to-one with each of the cold cathode tubes 17.

In the second embodiment, the relay member 350 is provided on one-side end of the chassis 14 to overlap one-side ends of the cold cathode tubes 17. The relay member 450 is provided on another-side end of the chassis 14 to overlap another-side ends of the cold cathode tubes 17. Configurations related to supply of driving power to the cold cathode tubes 17 and operations thereof will be explained.

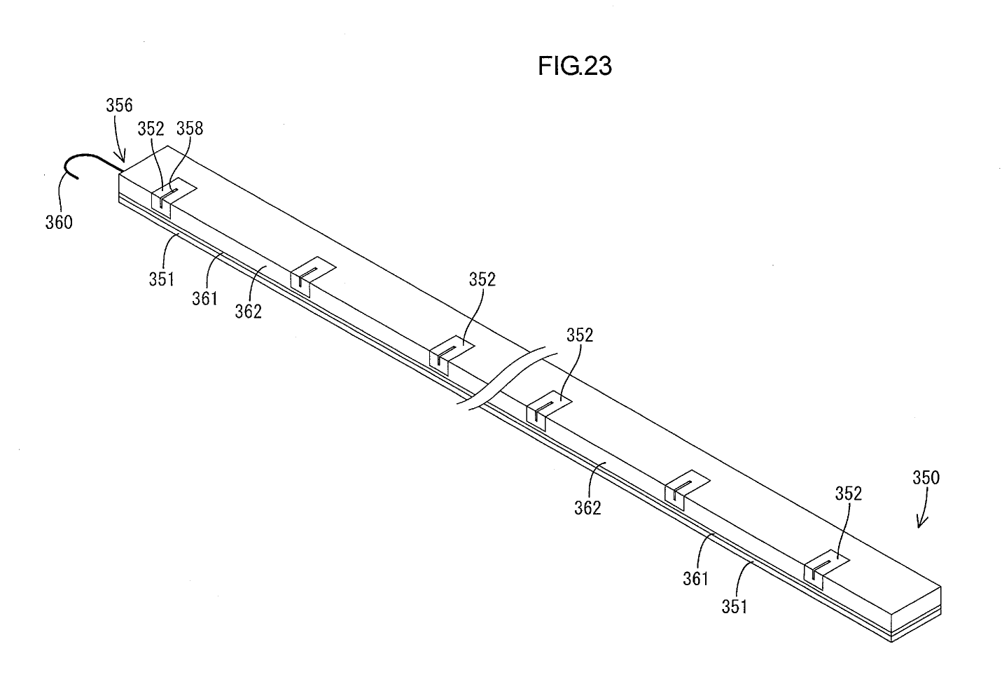

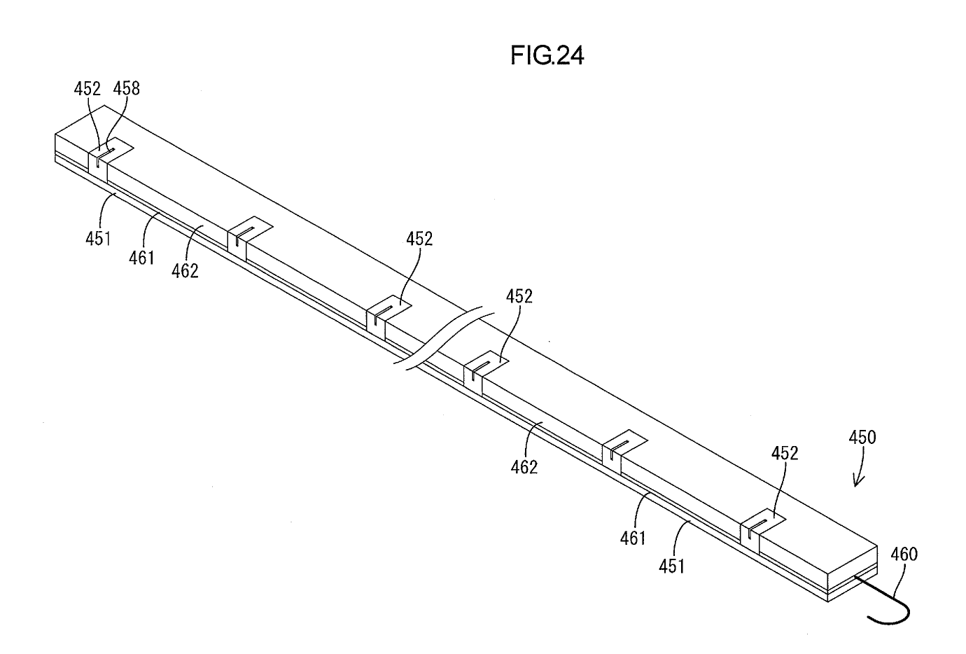

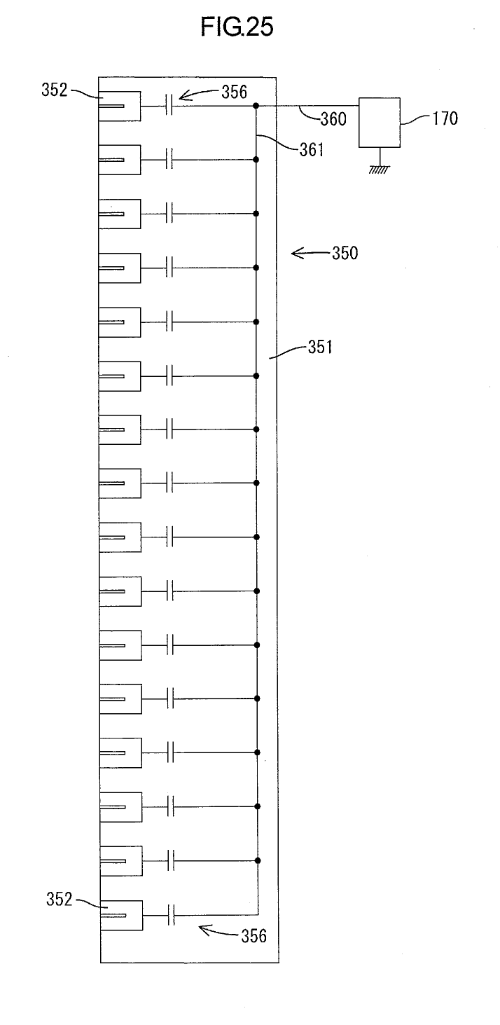

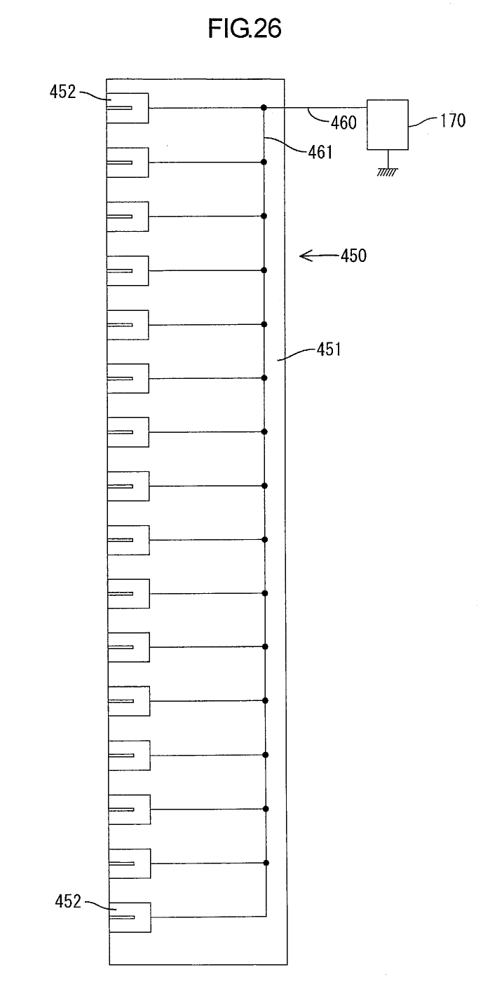

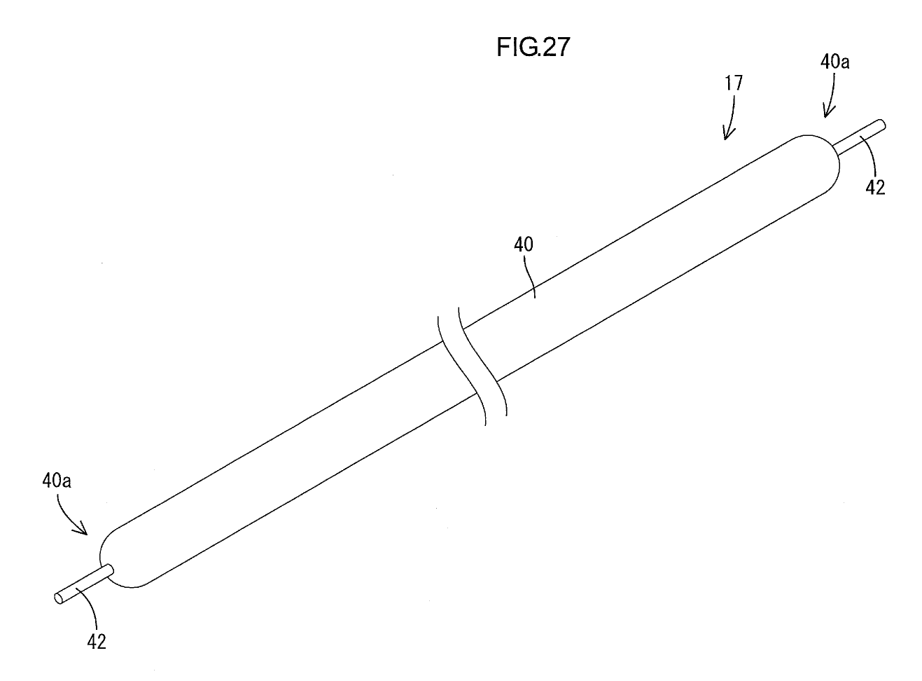

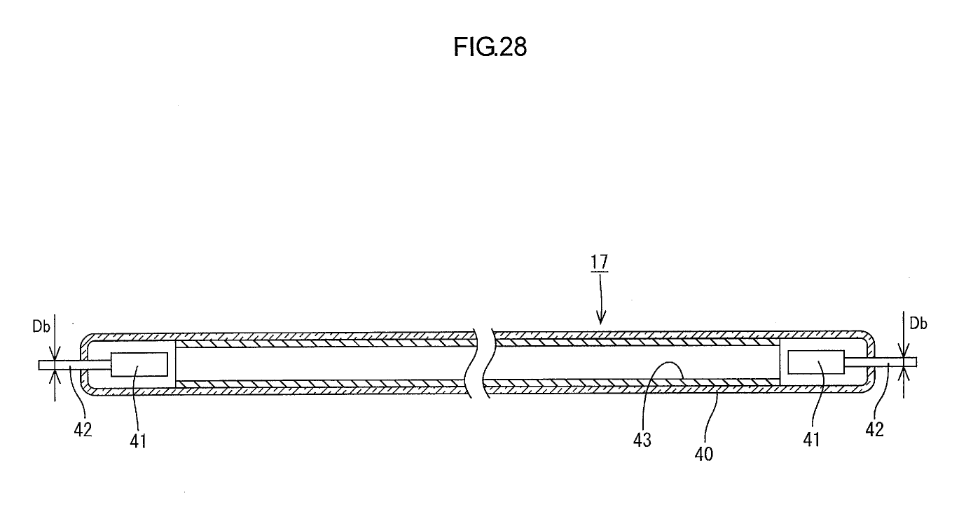

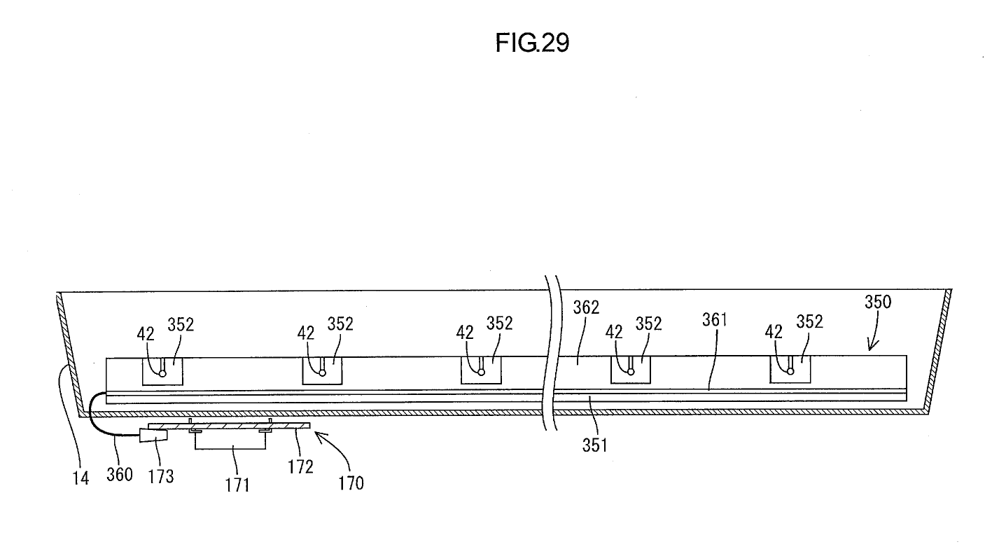

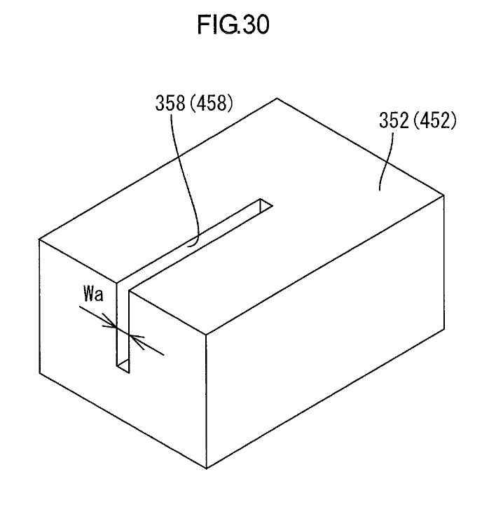

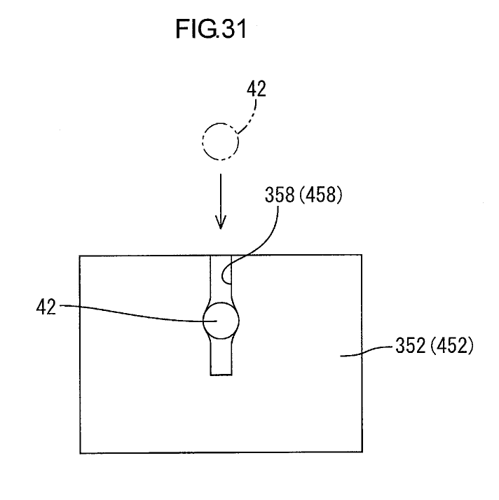

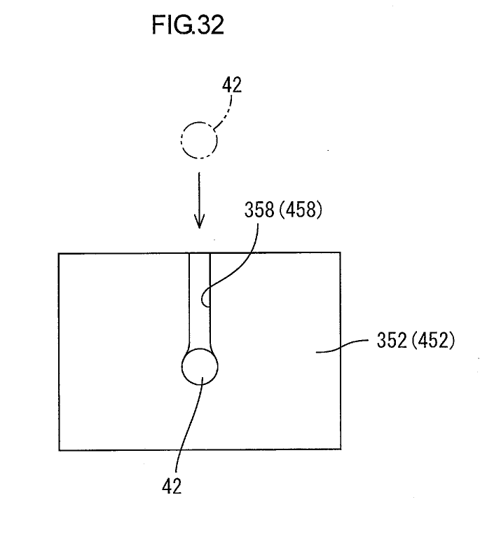

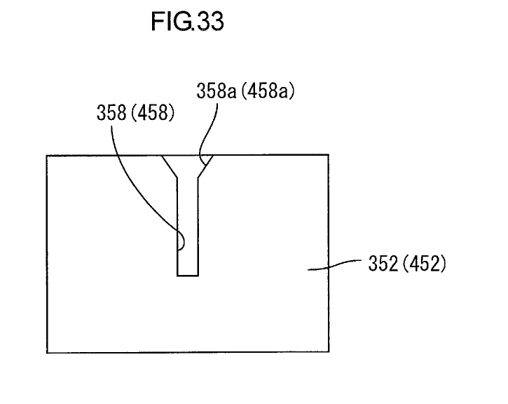

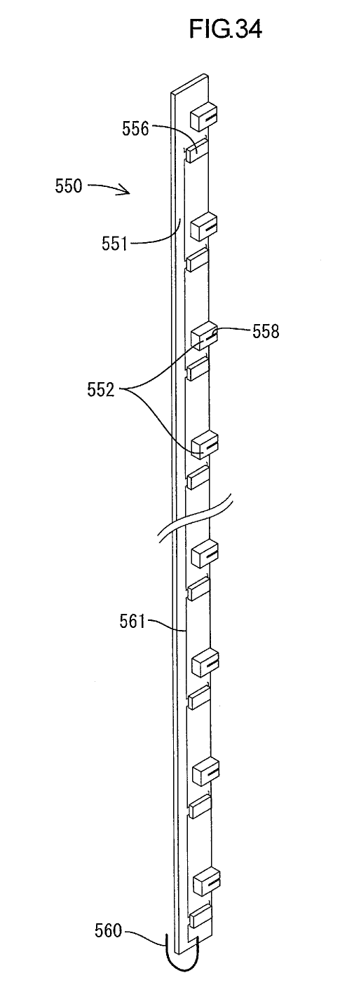

FIG. 23 is a perspective view illustrating a construction of the first relay member 350 including the relay bodies 352. FIG. 24 is a perspective view illustrating a construction of the second relay member 450 including the relay bodies 452. FIG. 25 is an explanatory view illustrating a circuit configuration related to power supply on the first relay member 350 side. FIG. 26 is an explanatory view illustrating a circuit configuration related to power supply on the second relay member 450 side. FIG. 27 is a perspective view illustrating a construction of the cold cathode tube 17 used in the second embodiment. FIG. 28 is a cross-sectional view illustrating a construction of the cold cathode tube 17. FIG. 29 is an explanatory view schematically illustrating a construction related to power supply on the first relay member 350 side. FIG. 30 is a perspective view illustrating a construction of the relay body 352 (452). FIG. 31 is an explanatory view illustrating a state in which the cold cathode tube 17 is being fitted (inserted) to the relay body 352 (452). FIG. 32 is an explanatory view illustrating a state in which the cold cathode tube 17 is fitted (inserted) to the relay body 352 (452). FIG. 33 is a plane view illustrating the relay body 352 (452) of a modification. FIG. 34 is a perspective view illustrating a relay member of a modification.

[Cold Cathode Tubes 17]

First, the construction of each cold cathode tube 17 will be explained.

The cold cathode tube 17 is formed in an elongated tubular shape and a plurality of the cold cathode tubes 17 are arranged in parallel to each other in the chassis 14 such that a longitudinal direction (axes) thereof matches the long-side direction of the chassis 14 (see FIG. 20). As illustrated in FIGS. 27 and 28, the cold cathode tube 17 includes an elongated glass tube 40 two ends of which are enclosed, electrodes 41 enclosed inside the both ends of the glass tube 40, and outer leads 42 extending to the outside of the glass tube 40 from the electrodes 41 respectively.

Noble gas and mercury are enclosed in the glass tube 40 and the inner surface of the glass tube 40 is coated with a fluorescent material 43. Portions at two ends of each cold cathode tube 17 provided with the electrodes 41 correspond to non-light-emitting portions and a middle portion of each cold cathode tube 17 (that is coated with the fluorescent material 43) corresponds to a light-emitting portion. Each outer lead 42 is attached to the corresponding relay body 352 (452) of the relay member 350 (450) such that the cold cathode tube 17 is fixed to the chassis 14. The relay member 350 (450) to which the ends of the cold cathode tubes 17 are attached is covered with a lamp holder 19.

The outer lead 42 is a terminal that establishes electric conductivity with external components. The outer lead 42 is a linear outer lead extending from each end of the glass tube 40 and having a longitudinal overall shape and a circular cross section with the same center as the glass tube 40. The outer leads 42 are made of metal (e.g., nickel or cobalt containing metal). An outer diameter Db of the outer lead 42 is substantially 0.5 mm to 1 mm and greater than an opening width Wa of an opening 158 of the relay body 152 (see FIG. 30).

[First Relay Member 350]

Next, a configuration of the first relay member 350 will be explained.

The first relay member 350 fixes the cold cathode tubes 17 to the chassis 14 and also relays power supplied from the power supply board 170 to the cold cathode tubes 17. The first relay member 350 of the present embodiment is provided along one-side end of the chassis 14. As illustrated in FIGS. 23 and 25, the first relay member 350 includes a base 351 formed of an elongated insulation substrate, a conductive layer (conductive portion) 361 provided on the base 351, a dielectric layer (dielectric portion) 362 formed of a layer made of a dielectric material and provided on the conductive portion 361, and the relay body 352 that is embedded in the dielectric layer 362 such that a surface of the relay body 352 is exposed from the surface of the relay member 350.

The base 351 is formed of a plate made of an insulation material such as glass-epoxy resin and attached and fixed to the chassis 14. A material used for the base 351 is not limited to glass-epoxy resin and any insulation materials such as paper phenol can be used for the base 351.

The conductive layer 361 is formed of a conductive layer made of metal such as copper foil that is provided on the base 351 with patterning. The conductive layer 361 is connected to the power supply board 170 via a harness (power supply path) 360. The conductive film 361 is formed as a common line to a plurality of relay bodies 352. One conductive layer 361 is formed on the base 351 to supply driving power from the conductive layer 361 to each relay body 352 via the dielectric layer 362.

The dielectric layer 362 is formed of a dielectric material such as metal oxide, metal nitride or resin. The dielectric layer 362 is disposed between the conductive layer 361 and the relay bodies 352 both of which are conductive and it forms a capacitor (balancing component) 356. The balancing component comprised of the capacitor 356 controls a current balance of driving power supplied to each relay body 352 or each cold cathode tube 17 to make the current supplied to each cold cathode tube 17 constant.

As illustrated in FIG. 25, each capacitor 356 is connected to the power supply board 170 in parallel and each capacitor 356 is connected to the conductive layer (common line) 361 in parallel here. Electrical connection with the power supply board 170 is collectively made through the harness 360 derived from the conductive layer 361. The capacitors 356 and the power supply board 170 are connected via lines that are less than the cold cathode tubes 17, specifically, connected via one harness 360. The harness 360 is routed from an edge of the base 351 disposed on the inner surface (inner surface side) of the chassis 14 to the power supply board 170 disposed on the outer surface (outer surface side) of the chassis 14, for example, as illustrated in FIG. 29.

The relay bodies 352 are provided so as to correspond one-to-one with a plurality of cold cathode tubes 17. The relay body 352 grips or holds the outer lead 42 of each cold cathode tube 17 to position and fix the cold cathode tube 17 (attach the cold cathode tube 17 to the chassis 14). The relay body 352 relays and supplies driving power to each cold cathode tube 17. According to the present embodiment, the relay body 352 is formed of conductive rubber to have conductivity and is elastically deformable. Specifically, as illustrated in FIG. 30, the relay body 352 is formed of conductive rubber formed in a cubic shape or a rectangular parallelpiped and has an opening 358 of a slit on its surface (upper surface) in which the outer lead 42 of the cold cathode tube 17 can be inserted. As illustrated in FIGS. 23 and 29, the cubic relay body 352 is embedded in the dielectric layer 362 so as to expose the opening 358 from the surface of the relay member 350. The outer lead 42 of the cold cathode tube 17 is inserted in the exposed opening (slit) 358 to position and fix the cold cathode tube 17.

In the present embodiment, the relay body 352 is made of conductive rubber, and an opening width Wa of the opening 358 is for example approximately 0.1 mm to 0.5 mm and is smaller than the outer diameter Db of the outer lead 42 as described above. Therefore, as illustrated in FIG. 31, at the time of insertion of the outer lead 42 in the opening 358, the opening 358 is elastically deformed to be enlarged. As illustrated in FIG. 32, when the outer lead 42 is completely inserted in the opening 358 of the relay body 352 (insertion is completed), the outer lead 42 is elastically in contact with an inner surface of the opening 358. The outer lead 42 is fixed tightly by elastic restoring force of the relay body 352 and it is not dropped off from the opening 358. Examples of the relay body 352 made of conductive rubber include one made by kneading carbon into a rubber material such as silicone rubber or one made by kneading particles of metal such as silver, copper or gold into a rubber material. As illustrated in FIG. 33, the opening portion of the opening 358 may be enlarged to form an insertion guide 358a to guide insertion of the outer lead 42 and make the insertion easier.

[Second Relay Member 450]

Next, a configuration of the second relay member 450 will be explained.

The second relay member 450 fixes the cold cathode tubes 17 to the chassis 14 and also relays power supplied from the power supply board 170 to the cold cathode tubes 17. The second relay member 450 of the present embodiment is provided along another-side end of the chassis 14 (a side end that is opposite from the side end on which the first relay member 350 is provided). As illustrated in FIGS. 24 and 26, the second relay member 450 includes a base 451 formed of an elongated insulation substrate, a conductive layer (conductive portion) 461 provided on the base 451, a dielectric layer (dielectric portion) 462 formed of a layer made of a dielectric material and provided on the conductive portion 461, and the relay body 452 that is embedded in the dielectric layer 462 such that a surface of the relay body 452 is exposed from the surface of the relay member 450.

The base 451 is formed of a plate made of an insulation material such as glass-epoxy resin and attached and fixed to the chassis 14. A material used for the base 451 is not limited to glass-epoxy resin and any insulation materials such as paper phenol can be used for the base 451.

The conductive layer 461 is formed of a conductive layer made of metal such as copper foil that is provided on the base 451 with patterning. The conductive layer 461 is connected to the power supply board 170 via a harness (power supply path) 460. The conductive film 461 is formed as a common line to a plurality of relay bodies 452. One conductive layer 461 is formed on the base 451 to supply driving power from the conductive layer 461 to each relay body 452. Unlike the first relay member 350, the conductive layer 461 is directly connected to the relay body 452 without intervening dielectric layer (without any intervening capacitors) to supply power.

An insulation layer 462 is disposed between the relay bodies 452. The insulation layer 462 is formed of a dielectric material such as metal oxide, metal nitride or resin and provides insulation between the relay bodies 452.

As illustrated in FIG. 26, each relay body 452 is connected to the power supply board 170 in parallel and each relay body 452 is connected to the conductive layer (common line) 461 in parallel here. Electrical connection with the power supply board 170 is collectively made through the harness 460 derived from the conductive layer 461.

The relay bodies 452 are provided so as to correspond one-to-one with a plurality of cold cathode tubes 17. The relay body 452 grips or holds the outer lead 42 of each cold cathode tube 17 to position and fix the cold cathode tube 17 (attach the cold cathode tube 17 to the chassis 14). The relay body 452 relays and supplies driving power to each cold cathode tube 17. According to the present embodiment, the relay body 452 is formed of conductive rubber to have conductivity and is elastically deformable. Specifically, as illustrated in FIG. 30, the relay body 452 is formed of conductive rubber formed in a cubic shape or a rectangular parallelpiped and has an opening 458 of a slit on its surface (upper surface) in which the outer lead 42 of the cold cathode tube 17 can be inserted. As illustrated in FIG. 24, the cubic relay body 452 is embedded in the insulation layer 462 so as to expose the opening 458 from the surface of the relay member 450. The outer lead 42 of the cold cathode tube 17 is inserted in the exposed opening (slit) 458 to position and fix the cold cathode tube 17.

In the present embodiment, the relay body 452 is made of conductive rubber, and an opening width Wa of the opening 458 is for example approximately 0.1 mm to 0.5 mm and is smaller than the outer diameter Db of the outer lead 42 as described above. Therefore, as illustrated in FIG. 31, at the time of insertion of the outer lead 42 in the opening 458, the opening 458 is elastically deformed to be enlarged. As illustrated in FIG. 32, when the outer lead 42 is completely inserted in the opening 458 of the relay body 452 (insertion is completed), the outer lead 42 is elastically in contact with an inner surface of the opening 458. The outer lead 42 is fixed tightly by elastic restoring force of the relay body 452 and it is not dropped off from the opening 458. Examples of the relay body 452 made of conductive rubber include one made by kneading carbon into a rubber material such as silicone rubber or one made by kneading particles of metal such as silver, copper or gold into a rubber material. As illustrated in FIG. 33, the opening portion of the opening 458 may be enlarged to form an insertion guide 458a to guide insertion of the outer lead 42 and make the insertion easier.

[Power Supply Board 170]

The power supply board 170 has a configuration same as the one in the first embodiment. Driving power supplied to the first relay member 350 and driving power supplied to the second relay member 450 from the power supply board 170 are in opposite phases. The driving power is supplied from the power supply board 170 to the first relay member 350 and the second relay member 450 so that the potential at the first relay member 350 and the second relay member 450 is higher than the potential at the chassis 14. Specifically, as illustrated in FIG. 56, one transformer 70 outputs driving power in opposite phases. The transformer 70 includes one primary coil 71, a first secondary coil 75 and a second secondary coil 76. The first second coil 75 has a relatively great number of coil turns and a second secondary coil 76 has a relatively small number of coil turns. The secondary coils 75, 76 are arranged for one primary coil 71. Accordingly, driving power of higher voltage is supplied to the one-end side of the cold cathode tubes 17 to which the capacitors 356 are connected (the side close to the first relay member 350) than another-end side of the cold cathode tubes 17 to which no capacitor 356 is connected (the side close to the second relay member 450).

The television receiver TV of the second embodiment includes the liquid crystal display device 10 having the backlight device (the lighting device) 12 of the present invention. Therefore, following operational effects are obtained.

Since the capacitors 356 are connected between the relay bodies 352 and the power supply board 170 to output the constant current for the driving power supplied to each relay body 352, the current supplied to each cold cathode tube 17 is uniform (constant). The cold cathode tubes 17 are driven in parallel with the common power source 170. The capacitors 356 are arranged on only one side of the cold cathode tubes 17, that is on only the side close to the first light relay member 350. This achieves cost reduction compared to a configuration in which the capacitors are arranged on two sides of the cold cathode tubes 17.

The power supply board 170 includes one transformer 70 and the transformer 70 outputs driving power to the first relay member 350 and the second relay member 450. The driving power output to the first relay member 350 and the second relay member 450 are in opposite phases. This achieves cost reduction compared to a case in which separate transformers are provided to supply driving power in opposite phases. Especially, in the present embodiment, when driving power is supplied to two ends of the cold cathode tube 17, driving power of higher voltage is supplied to the one end side of the cold cathode tubes 17 to which the capacitors 356 are connected than the other end side of the cold cathode tube 17 to which no capacitor is connected. A position of an imaginary ground in a longitudinal direction of the cold cathode tube 17 is shifted close to a center. This improves bilateral symmetric brightness.

The outer lead 42 is just inserted in the opening 358 (458) of the relay body 352 (452) without attaching an external electrode such as a ferrule to the cold cathode tube 17 to easily establish electric conductivity or power supply to the cold cathode tubes 17. Thus, since the external electrode is not provided, the number of components is reduced and a cost reduction is achieved.

The relay body 352 (452) is formed of conductive rubber, and in the state that the outer lead 42 is inserted in the opening 358 (458), the elastic deformation of the conductive rubber ensures reliable contact and reliable electric conductivity between the outer lead 42 and the inner surface of the opening 358 (458). Therefore, the elastic contact reliably ensures the contact between the outer lead 42 and the inner surface of the opening 358 (458) even if a small positional gap (relative movement) is generated therebetween. If a dimension error in manufacturing occurs in the relay body 352 (452) (for example, the opening 358 (458)) and the cold cathode tube 17 (outer lead 42), the elasticity compensates for the error to ensure the reliable contact between the outer lead 42 and the inner surface of the opening 358 (458). As a result, conductivity of the relay member 350 (450) is highly reliable and the backlight device 12 hardly causes light emission errors due to conductivity errors. The relay body 352 (452) formed of rubber makes the outer lead 42 to be elastically in contact with the inner surface of the opening 358 (458). Accordingly, excessive stress is hardly applied to the outer lead 42 and the outer lead 42 is less likely to be damaged. This hardly causes errors such as light emission errors.

The relay body 352 (452) is configured such that the opening 358 (458) has the width Wa smaller than the outer diameter Db of the outer lead 42 in the state that the outer lead 42 is not inserted in the opening 358 (458). Therefore, the insertion of the outer lead 42 in the opening 358 (458) enlarges the opening 358 (458) due to its elastic deformation, and the inner surface of the opening 358 (458) is elastically in contact with the outer lead 42 reliably due to its elastic restoring force. This ensures the above-described reliable electric conductivity.

FIG. 34 is a perspective view illustrating a construction of the first relay member 350. The first relay member 550 includes chip capacitors 556 as the balancing components. The chip capacitors 556 are arranged so as to correspond one-to-one with the relay bodies 552. The chip capacitors 556 and the relay bodies 552 are arranged on a base 551 that is formed of an insulation substrate made of glass-epoxy resin or paper phenol. Each of the relay bodies 552 has an opening 558 and formed of conductive rubber in a cubic shape. The chip capacitors 556 are connected to the power supply board (the power source) 170 in parallel and the chip capacitors 556 are connected to the conductive layer (the common line) 561 in parallel. Electrical connection with the power supply board (the power source) 170 is collectively made through the harness 560 derived from the conductive layer 561.

### Third Embodiment

A third embodiment of the present invention will be explained.

In the third embodiment, a first light source holding member (a first power relay board) 650 is provided for the first light source holding member 150 of the first embodiment and a second light source holding member (a second power relay board) 750 is provided for the second light source holding member 250 of the first embodiment. Other components are same as those in the first embodiment and are indicated by the same symbols and may not be explained.

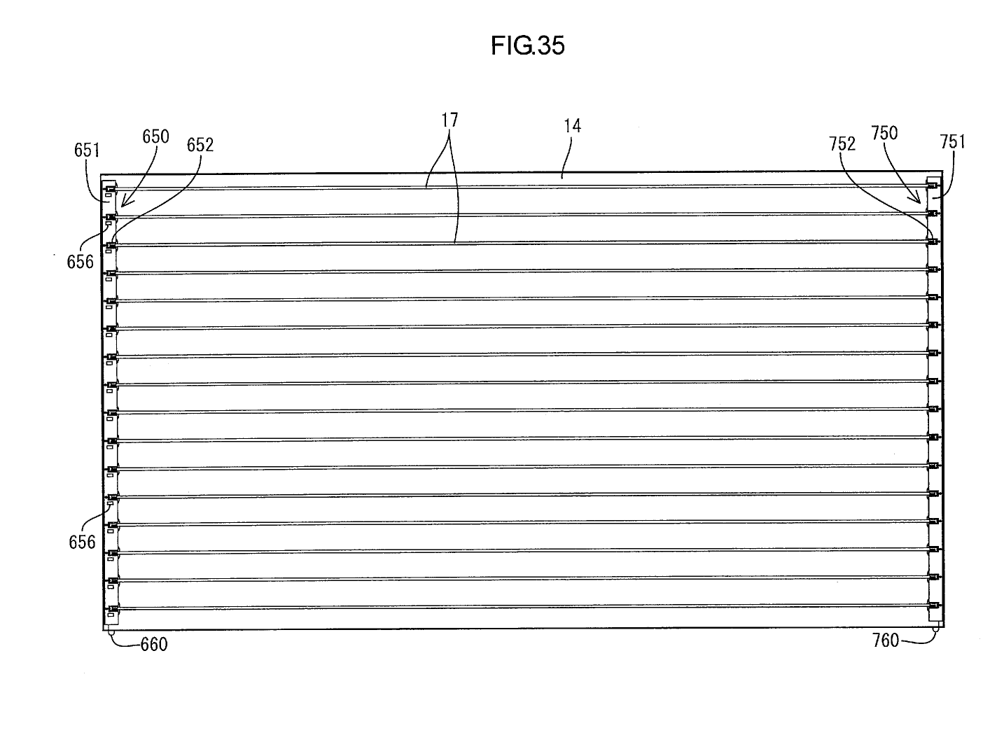

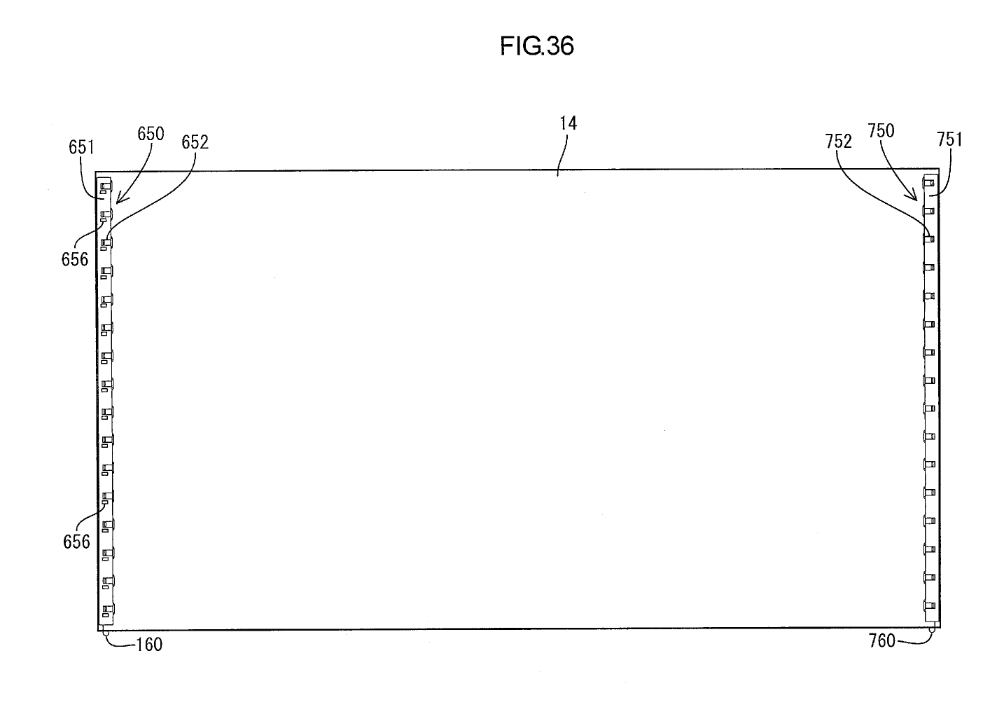

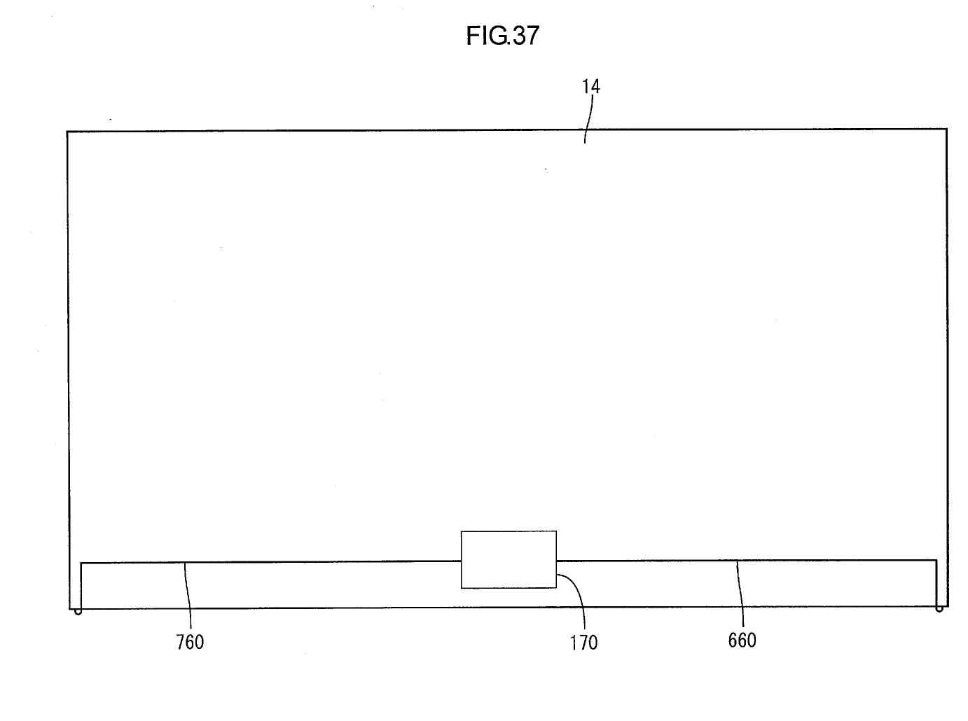

FIG. 35 is a front view illustrating a main construction of a lighting device included in a liquid crystal display device of a television receiver according to a third embodiment. FIG. 36 is a front view illustrating the main construction of the backlight device. FIG. 37 is a rear view illustrating the main construction of the backlight device. In the third embodiment, the cold cathode tubes 17 are arranged in parallel on the front-surface side of the chassis 14 and the power supply board 170 is arranged on the rear-surface side of the chassis 14. The power supply board 170 supplies driving power to drive the cold cathode tubes 17 in parallel. Driving power supplied to one-end side of the cold cathode tubes 17 and driving power supplied to another-end side of the cold cathode tubes 17 are in opposite phases.

Specifically, as illustrated in FIGS. 35 and 36, power relay boards 650, 750 are arranged on the front-surface side of the chassis 14. The power relay boards 650, 750 relay (connect with electric conductivity) the driving power supplied from the power supply board 170 to each cold cathode tube 17. Each of the relay boards 650, 750 includes a base 651, 751 formed of an insulation substrate and relay electrodes 652, 752 mounted on the base 651, 751. The relay electrode 652, 752 are formed in a chip and mounted with one-to-one correspondence with each of the cold cathode tubes 17. In the third embodiment, the first power relay board 650 is provided on one-side end of the chassis 14 so as to overlap one-side end of the cold cathode tubes 17. The second power relay board 750 is provided on another-side end of the chassis 14 so as to overlap another-side end of the cold cathode tubes 17. A configuration related to driving power supply to the cold cathode tubes 17 and operations thereof will be explained.

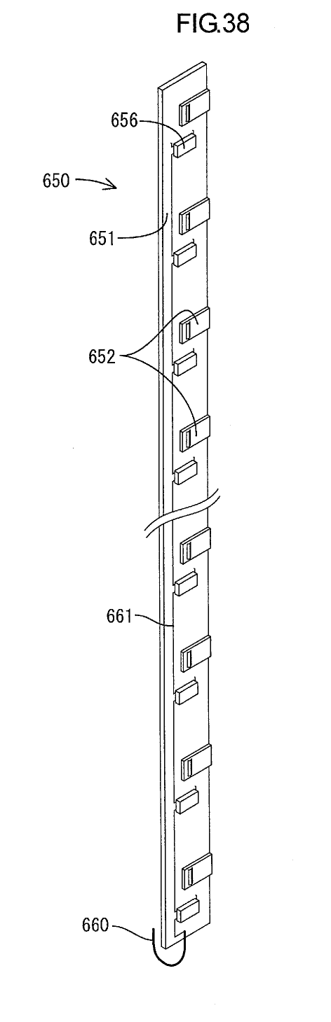

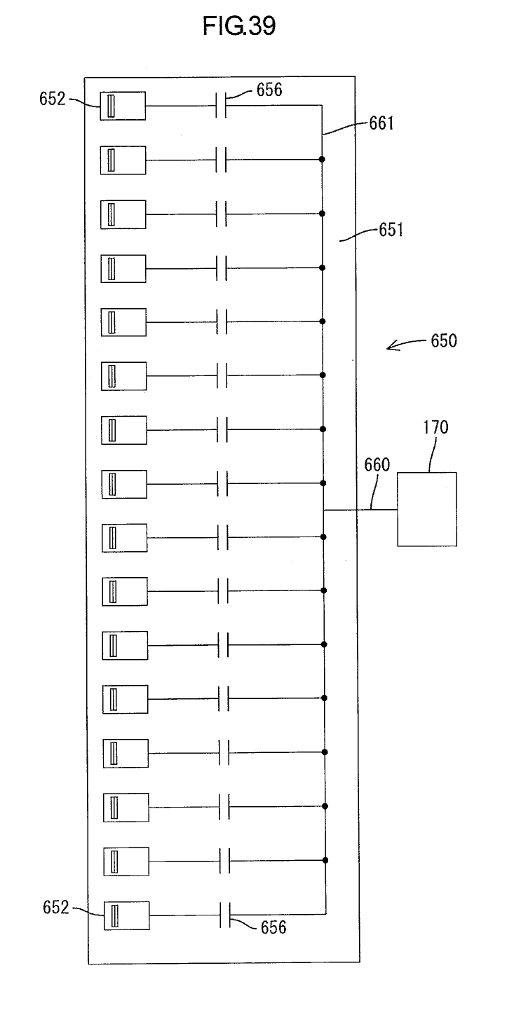

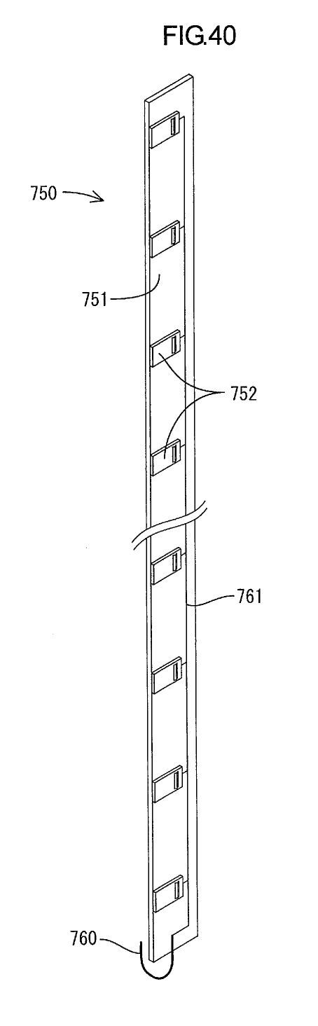

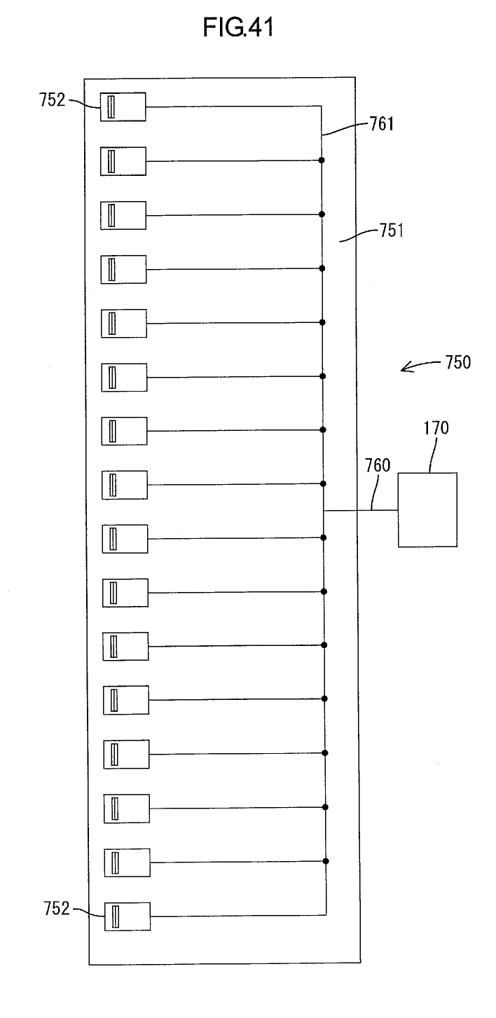

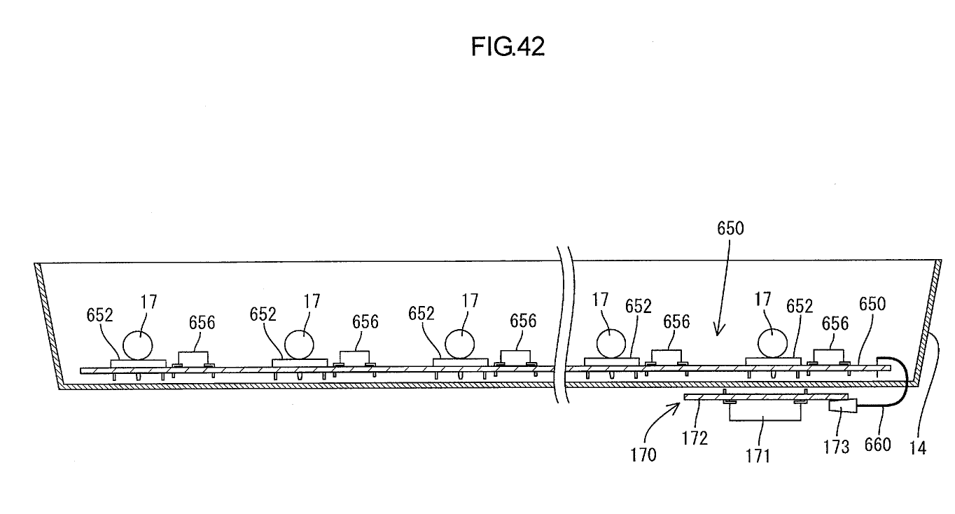

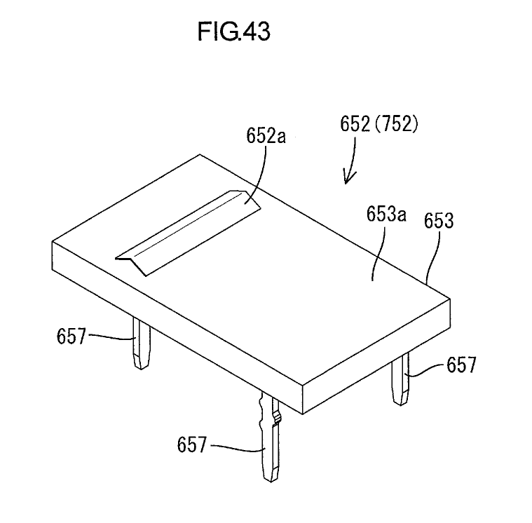

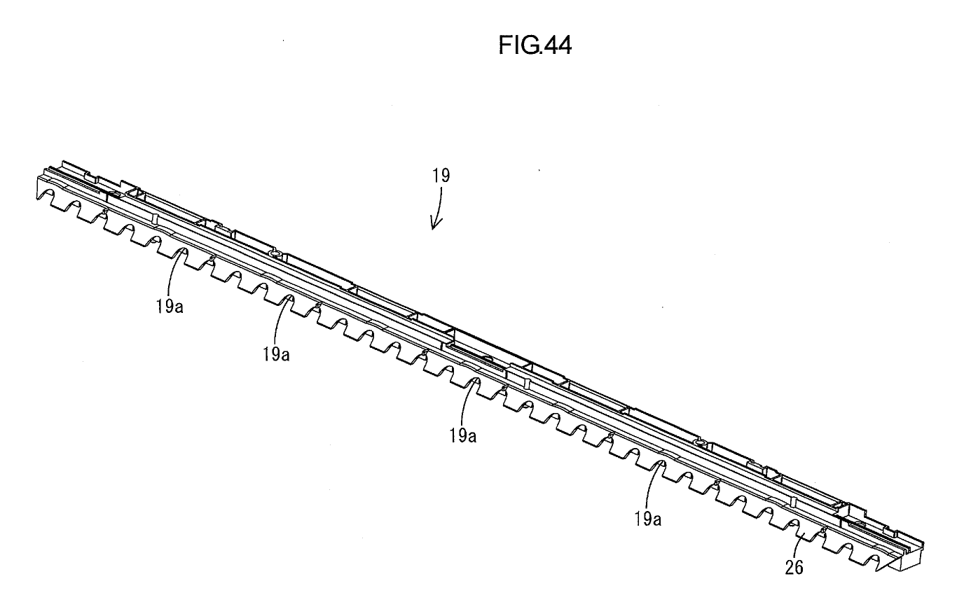

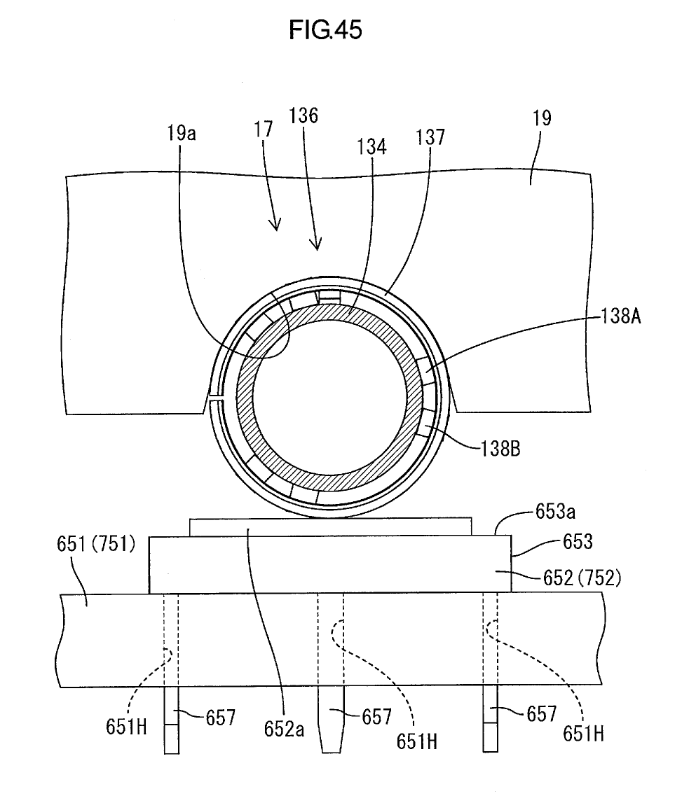

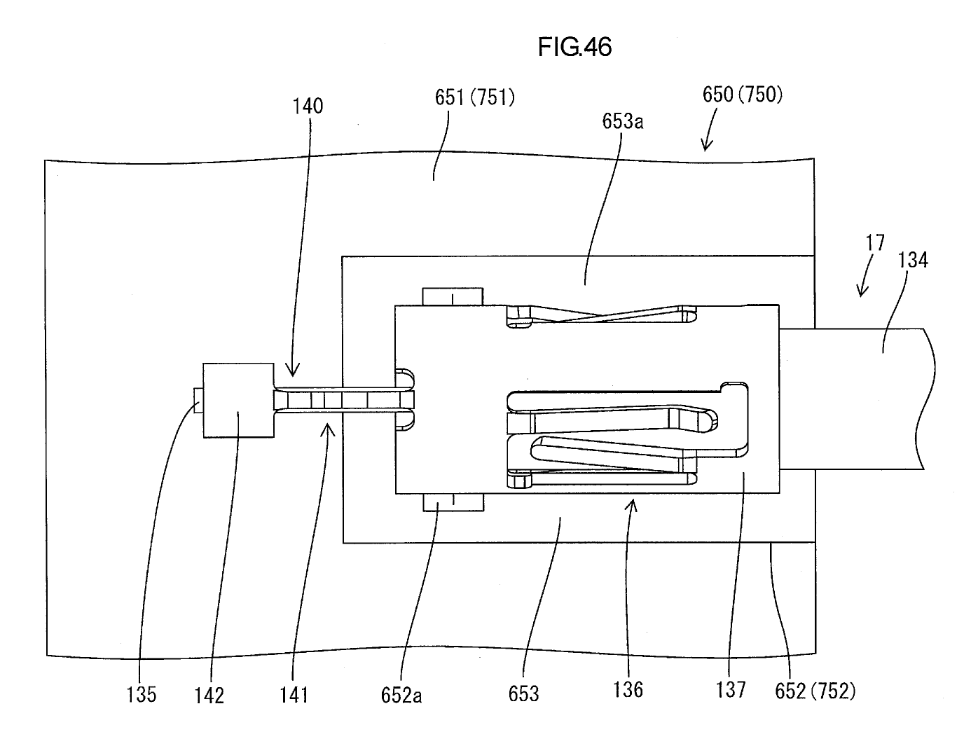

FIG. 38 is a perspective view illustrating a general construction of the first power relay board 650 including the relay electrodes 652. FIG. 39 is an explanatory view illustrating a power supply circuit configuration on the first power relay board 650. FIG. 40 is a perspective view illustrating a general construction of the second power relay board 750 including the relay electrodes 752. FIG. 41 is an explanatory view illustrating a power supply circuit configuration on the second power relay board 750. FIG. 42 is an explanatory view schematically illustrating a construction related to power supply on the first power relay board 650. FIG. 43 is a perspective view illustrating a construction of the relay electrode 652 (752). FIG. 44 is a perspective view illustrating a construction of the lamp holder 19 that covers the cold cathode tubes 17 from the front surface side. FIG. 45 is a front view illustrating a state in which the cold cathode tube 17 is placed on the relay electrode 652 (752). FIG. 46 is a plan view illustrating a state in which the cold cathode tube 17 is placed on the relay electrode 652 (752).

[Cold Cathode Tube 17]

The cold cathode tube 17 is same as the one in the first embodiment and includes the ferrules 136 at ends of the glass tube 134 (see FIGS. 13 and 14).

[First Power Relay Board 650]

Next, a construction of the first power relay board 650 will be explained.

The first power relay board 650 has a function for relaying power supply to the cold cathode tubes 17. As illustrated in FIG. 38, the first power relay board 650 includes an elongated base 651 that is formed of an insulation substrate and mounted to one-side end of the chassis 14, a plurality of relay electrodes 652 mounted on the front-surface side of the base 651, and chip capacitors 656 for outputting a constant electrical current for the driving power supplied to each relay electrode 652. The base 651 has three mounting through holes 651H for each relay electrode 652 as illustrated in FIG. 45.

As illustrated in FIG. 43, each relay electrode 652 includes a base 653 that is formed of conductive metal and formed in a chip or a rectangular shape and a leaf spring (elastic member) 652a that is formed of a conductive metal material and provided on a placing surface 653a of the base 653. The placing surface 653a is a flat surface. The leaf spring 652a is equipotential to the base 653 and it applies an elastic reaction force to the ferrule 136 that is placed on the placing surface 653a. The leaf spring 652a is elastically deformed by an urging force applied from the ferrule 136 to the placing surface 653a. Namely, the leaf spring 652a is disposed between the placing surface 653a and the ferrule 136 in the elastically deformed state. Three legs 657 are integrally formed on a rear surface of the base 653. The relay electrode 652 is not housed in a housing member or the like made of a synthetic resin, and directly fixed to the base 651 by soldering and the like without any covering with the legs 657 passed through the mounting holes in the base 651.

The chip capacitors 656 are provided with one-to-one correspondence with each of the relay electrodes 652 and the chip capacitors 656 and the relay electrodes 652 are mounted on the base 651. The chip capacitors 656 are connected to the power supply board (the power source) 170 in parallel and the chip capacitors 656 are connected to the common line 661 in parallel. Electrical connection with the power supply board 170 is collectively made through the line (the harness) 660 derived from the common line 661.

[Second Power Relay Board 750]

Next, a construction of the second power relay board 750 will be explained.

The second power relay board 750 has a function for relaying power supply to the cold cathode tubes 17. As illustrated in FIG. 40, the second power relay board 750 includes an elongated base 751 that is formed of an insulation substrate and mounted to another-side end of the chassis 14 (a side end opposite from the one where the firs power relay board 750 is mounted), and a plurality of relay electrodes 752 mounted on the front-surface side of the base 751. The base 751 has three mounting through holes 651H for each relay electrode 752 as illustrated in FIG. 45.

As illustrated in FIG. 43, each relay electrode 752 has a similar construction as the relay electrode 652 and includes a base 653 that is formed of conductive metal and formed in a chip or a rectangular shape and a leaf spring (elastic member) 652a that is formed of a conductive metal material and provided on a placing surface 653a of the base 653. The placing surface 653a is a flat surface. The leaf spring 652a is equipotential to the base 653 and it applies an elastic reaction force to the ferrule 136 that is placed on the placing surface 653a. The leaf spring 652a is elastically deformed by an urging force applied from the ferrule 136 to the placing surface 653a. Namely, the leaf spring 652a is disposed between the placing surface 653a and the ferrule 136 in the elastically deformed state. Three legs 657 are integrally formed on a rear surface of the base 653. The relay electrode 752 is not housed by a housing member or the like made of a synthetic resin, and directly fixed to the base 751 by soldering and the like without any covering with the legs 657 passed through the mounting holes in the base 751.

The relay electrodes 752 are connected to the common line 761 and connected to the power supply board (the power source) 170 in parallel. Electrical connection with the power supply board 170 is collectively made through the line (the harness) 760 derived from the common line 761. Unlike the first power relay board 650, the power supply board 170 is directly (without having intervening capacitors) connected to the relay electrodes 752 via the common line 761 to supply power.

[Lamp Holder 19]

The lamp holder 19 covers the ends (the ferrules 136) of the cold cathode tubes 17 and has a configuration illustrated in FIG. 44. The lamp holder 19 is formed in an elongated substantially box shape extending in the alignment direction of the cold cathode tubes 17, and is made of a synthetic resin having a surface in white color that provides reflectivity. A sloped cover (sloped portion) 26 extends from an upper surface of the lamp holder 19 toward a center of the cold cathode tubes 17 and toward a bottom plate of the chassis 14. Openings 19a into which the cold cathode tubes 17 are inserted are formed in the sloped cover 26. The number of openings 19a is same as that of cold cathode tubes 17. The portions of the cold cathode tubes 17 that are inserted in the lamp holder 19 from the opening (covered portions) are connected to the power supply board 170 via the power relay board 650 (750) with conductivity. In the present embodiment, as illustrated in FIG. 45, the lamp holder 19 presses the upper side (front side) of the cold cathode tube 17 to urge the cold cathode tube 17 toward the placing surface 653a of the relay electrode 652 (752).

[Power supply board 170]

The power supply board 170 includes a configuration same as that of the first embodiment and the driving power supplied to the first power relay board 650 and the driving power supplied to the second power relay board 750 are in opposite phases. The driving power is supplied to the first power relay board 650 and the second power relay board 750 so that the potential at the first power relay board 650 and the second power relay board 750 is higher than the potential at the chassis 14. As illustrated in FIG. 56, one transformer 70 outputs driving power in opposite phases. The transformer 70 includes one primary coil 71, a first secondary coil 75 and a second secondary coil 76. The first secondary coil 75 has a relatively great number of coil turns and the second secondary coil 76 has a relatively small number of coil turns. The secondary coils 75, 76 are arranged for one primary coil 71. Accordingly, driving power of higher voltage is supplied to the one end side to which the capacitors 656 of the cold cathode tubes 17 are connected (the side close to the first power relay board 650) than another end side to which no capacitor of the cold cathode tube 17 is connected (the side close to the second power relay board 750).

[Power Supply Method]

Reliable power supply to the cold cathode tubes 17 can be achieved by the power relay board 650 (750) provided with the relay electrodes 652 (752) and the lamp holders 19.

When the ferrule 136 of the cold cathode tube 17 is placed on the placing surface 653a of the relay electrode 652 (752), the driving power can be supplied to the cold cathode tube 17. There is provided no clip mechanism for holding the cold cathode tubes 17. Namely, as illustrated in FIG. 45, the cold cathode tube 17 (the ferrule 136, subsequently) urged by the lamp holder 19 that is provided independently from the relay electrode 652 (752) is received by the leaf spring 652a with its elastic reaction force. Accordingly, the leaf spring 652a is disposed between the placing surface 653a and the ferrule 136 in an elastically deformed state so as to achieve reliable contact (electric conductivity) between the ferrule 136 and the relay electrode 652 (752) (including the leaf spring 652a).

According to the television receiver TV of the third embodiment, the liquid crystal display device 10 includes the backlight device (lighting device) 12 having the configuration of the present invention. Therefore, it provides the following operation effects.

Since the chip capacitors 656 are connected between the relay electrodes 652 and the power supply board 170 to output the constant current for the driving power supplied to each relay electrode 652, the current supplied to each cold cathode tube 17 is uniform (constant). The cold cathode tubes 17 are driven in parallel with the common power source 170. The chip capacitors 656 are arranged on only one side of the cold cathode tubes 17, that is on only the side close to the first power relay board 650. This achieves cost reduction compared to a configuration in which the capacitors are arranged on two sides of the cold cathode tubes 17.

The power supply board 170 includes one transformer 70 and the transformer 70 outputs driving power to the first power relay board 650 and the second power relay board 750. The driving power output to the first power relay board 650 and the driving power output to the second power relay board 750 are in opposite phases. This achieves cost reduction compared to a case in which separate transformers are provided to supply driving power in opposite phases. Especially, in the present embodiment, when driving power is supplied from two ends of the cold cathode tube 17, driving power of higher voltage is supplied to the one end side of the cold cathode tubes 17 to which the ballast capacitors 56 are connected than the other end side of the cold cathode tube 17 to which no capacitor is connected. A position of an imaginary ground in a longitudinal direction of the cold cathode tube 17 is shifted close to a center. This improves bilateral symmetric brightness.

On the power relay board 650 (750) that connects the power supply board 170 and the cold cathode tubes 17, the ferrule 136 of the cold cathode tube 17 is placed on the placing surface 653a of the relay electrode 652 (752) and this enables driving power to be supplied to the cold cathode tubes 17 via the relay electrodes 652 (752). The lamp holder 19 that urges the cold cathode tubes 17 toward the placing surface 653a side is provided independently from the relay electrodes 652 (752), each of the relay electrodes 652 (752) is configured to be in a quite simple chip and electric conductivity to the cold cathode tubes 17 becomes reliable. Namely, the member that urges the cold cathode tubes 17 (the lamp holder 19) is provided independently from the relay electrode 652 (752), and therefore the relay electrode 652 (752) has a simple configuration in which the ferrule 136 is placed on the placing surface 653a of the relay electrode 652 (752) and is not required to have a configuration in which the cold cathode tube 17 is held or fixed by the holding member such as a clip and the like. This simplifies the configuration.

The conductive leaf spring 652a is disposed between the ferrule 136 and the placing surface 653a with being elastically deformed, and this ensures electric conductivity between the ferrule 136 and the placing surface 653a (the relay electrode 652 (752)). As described above, in the present embodiment, the cold cathode tube 17 is urged toward the placing surface 653a by the lamp holder 19 to achieve reliable contact between the ferrule 136 and the placing surface 653a. The leaf spring 652a provided on the placing surface 635a enables the ferrule 136 and the placing surface 653a to be in contact with each other surely even if a slight position gap (relative movement) is caused between the ferrule 136 and the placing surface 653a. This ensures further reliable electric conductivity. Even if dimension error in manufacturing occurs in the relay electrode 652 (752), the cold cathode tube 17 and the lamp holder 19, the leaf spring 152a absorbs the error to achieve the reliable contact between the ferrule 136 and the placing surface 653a. In addition to the function for urging the cold cathode tube 17 toward the placing surface 653a, the lamp holder 19 also covers ends of the cold cathode tubes 17 that are non-light emitting portions, the ferrule 136 here, such that shadows of the non-light emitting portions are not projected on the illumination light.

Modifications of the third embodiment will be explained. In each of the modifications, points that are different from the components in the third embodiment will be mainly explained. In the following modifications, the same parts as the third embodiment are indicated by the same symbols and will not be explained.

[First Modification]

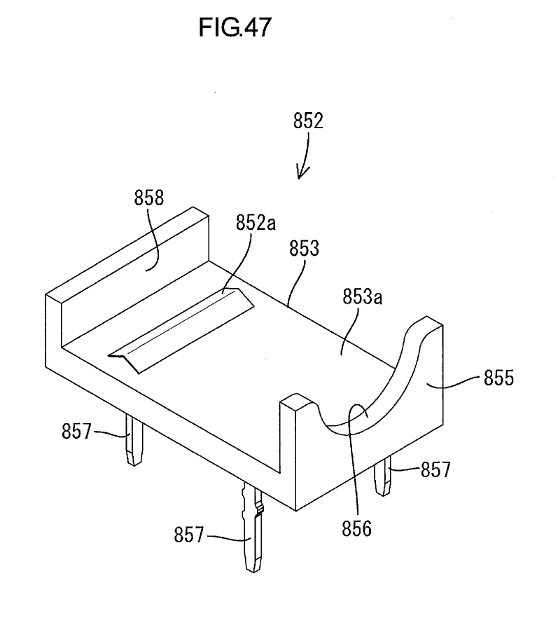

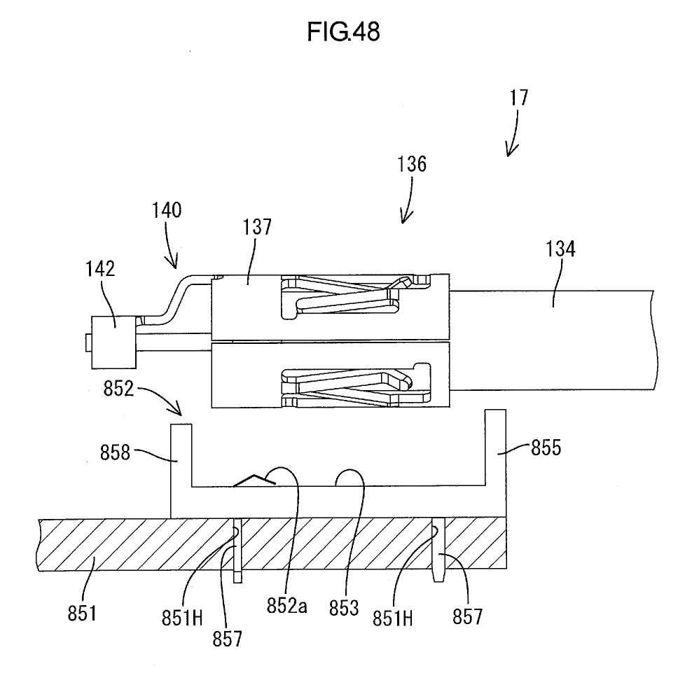

A modification of the relay electrode 652 (752) is shown in FIGS. 47 and 48. FIG. 47 is a perspective view illustrating a configuration of a relay electrode 852 according to the first modification. FIG. 48 is an explanatory view illustrating a connecting relation between the relay electrode 852 and the cold cathode tube 17.

Each relay electrode 852 illustrated in FIG. 16 includes a base 853 that is formed of conductive metal and formed in a chip or a rectangular shape and a leaf spring (elastic member) 852a that is formed of a conductive material and provided on a placing surface 853a of the base 853. The placing surface 853a is a flat surface. The leaf spring 852a is equipotential to the base 853 and it applies an elastic reaction force to the ferrule 136 that is placed on the placing surface 853a. The leaf spring 852a is elastically deformed by an urging force applied from the ferrule 136 to the placing surface 853a. Namely, the leaf spring 852a is in the elastically deformed state between the placing surface 853a and the ferrule 136.

Similar to the above embodiment, three legs 857 are integrally formed on a rear surface of the base 853. Walls (light source movement restricting member) 855, 858 are formed at a front end and a rear end of the base 853. As illustrated in FIG. 48, the walls 855, 858 extend upwardly from two ends of the placing surface 853a of the base 853 in an axial direction of the cold cathode tube 17 in a state that the cold cathode tube 17 is placed on the placing surface 853a. The walls 855, 858 restrict axial movement of the cold cathode tube 17. A part of the wall 855 among the walls 855, 858 that is provided at a front side (closer to a center of the cold cathode tube 17) is cut in an arc shape to form a cutaway portion 856 for receiving a glass tube 134 of the cold cathode tube 17. To restrict the movement of the cold cathode tube 17, at least the wall 858 provided at a back side (closer to the end of the cold cathode tube 17) is provided and the wall 855 provided at the front side may be omitted.

Similar to the relay electrode 652 (752) of the above embodiment, the relay electrode 852 of the modification is not housed by a housing member and the like made of a synthetic resin, and directly fixed to the base 851 by soldering and the like without any covering with the legs 857 passed through the mounting holes 851H in the base 851 to configure the first power relay board or the second power relay board.

[Second Modification]

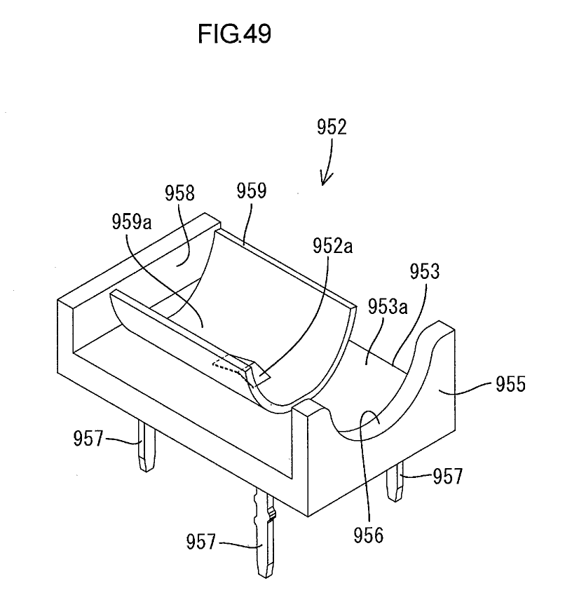

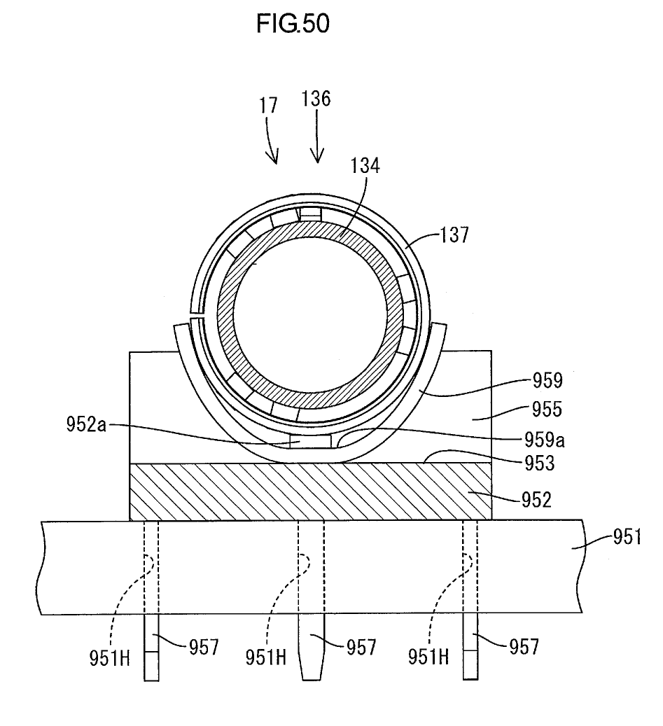

Another modification of the relay electrode 652 (752) is shown in FIGS. 49 and 50. FIG. 49 is a perspective view illustrating a configuration of a relay electrode 952 according to the second modification. FIG. 50 is an explanatory view illustrating a connecting relation between the relay electrode 952 and the cold cathode tube 17.

Each relay electrode 952 illustrated in FIG. 49 includes a base 953 that is formed of conductive metal and formed in a chip or a rectangular shape, an arc shaped cup (arc-shaped receiving member) 959 that is formed of conductive metal and placed on a placing surface 953a of the base 953, and a leaf spring (elastic member) 952a that is provided on a bottom surface of the cup 959. The cup 959 is configured to receive a lower portion of the ferrule 136 of the cold cathode tube 17, that corresponds to a half or less of the tubular periphery of the ferrule 136, and a cross section of the cup 959 with respect to a direction crossing to the axial direction of the cold cathode tube 17 is an arc having a semi-circular shape or smaller.

Similar to the above embodiment, the leaf spring 952a is equipotential to the base 953 and the cup 959. As illustrated in FIG. 50, the leaf spring 952a applies an elastic reaction force to the ferrule 136 that is placed on the placing surface 959a of the cup 959 with the ferrule 136 being received in the cup 959. The leaf spring 952a is elastically deformed by an urging force applied from the ferrule 136 to the placing surface 959a. Namely, the leaf spring 952a is in the elastically deformed state between the placing surface 959a and the ferrule 136.

Similar to the above embodiment, three legs 357 are integrally formed on a rear surface of the base 953. Walls (light source movement restricting member) 955, 958 are formed at a front end and a rear end of the base 953. The walls 955, 958 extend upwardly from two ends of the placing surface 959a in an axial direction of the cold cathode tube 17 in a state that the cold cathode tube 17 is placed on the placing surface 959a. The walls 955, 958 restrict axial movement of the cold cathode tube 17. A part of the wall 958 among the walls 955, 958 that is provided at a front side (closer to a center of the cold cathode tube 17) is cut in an arc shape to form a cutaway portion 956 for receiving a glass tube 134 of the cold cathode tube 17. To restrict the movement of the cold cathode tube 17, at least the wall 958 is provided at a back side (closer to the end of the cold cathode tube 17) and the wall 955 provided at the front side may be omitted.

Similar to the relay electrode 652 (752) of the above embodiment, the relay electrode 952 of this modification is not housed by a housing member and the like made of a synthetic resin, and directly fixed to the base 951 by soldering and the like without any covering with the legs 957 passed through the mounting holes 951H in the base 951 to configure the first power relay board or the second power relay board. The relay electrode 952 of this modification includes the cup 959 that receives a lower portion of the ferrule 136. Therefore, the cold cathode tube 17 (the ferrule 136) can be located in a certain position. Since the cup 959 is configured to receive a lower portion of the cold cathode tube 17 (the ferrule 136), the cup 959 is not damaged and a specific component such as a reinforcing member is not required to be provided compared to a case in which the cold cathode tube 17 is held by a clip.

[Third Modification]

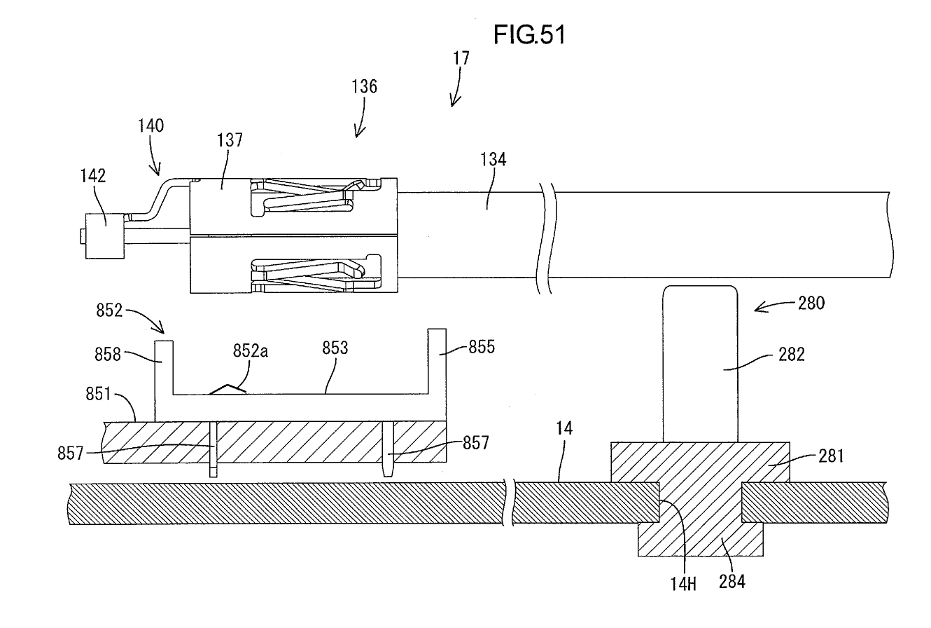

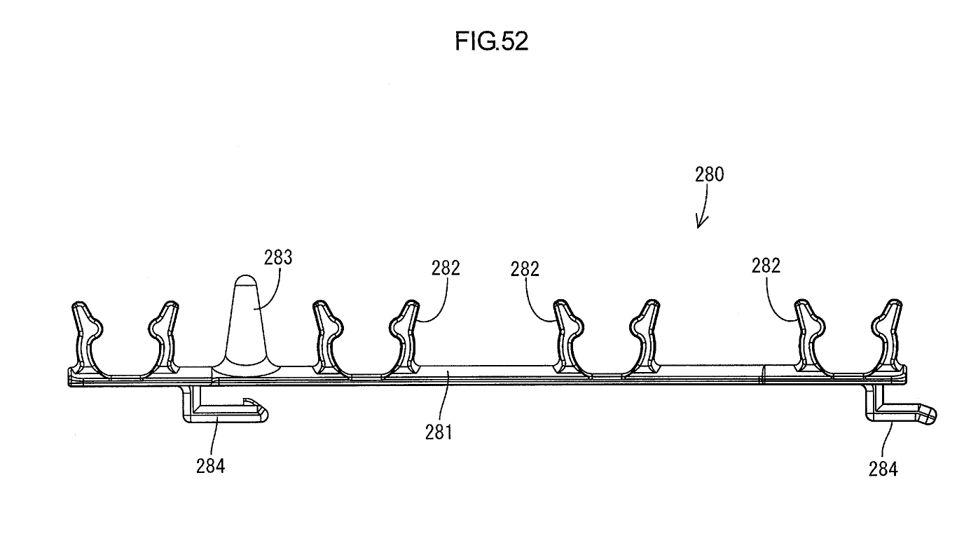

A lamp clip 280 may be provided as holding means for holding the cold cathode tube 17. FIG. 51 is an explanatory view illustrating a relation between the lamp clip 280 and the cold cathode tube 17. FIG. 52 is a front view illustrating a construction of the lamp clip 280.

As illustrated in FIGS. 51 and 52, the lamp clip 280 fixes the cold cathode tubes 17 to the chassis 14. The lamp clip 280 includes a base plate (a mounting plate) 281 that is placed on the chassis 14, holding portions 282, engagement portions 284 and a support pin 283. The holding portions 282 project from the base plate 281 toward the cold cathode tubes 17 to hold the cold cathode tubes 17. The engagement portions 284 project from the base plate 281 toward the chassis 14 to be engaged to a rear surface of the chassis 14 through mounting holes 14H provided in the chassis 14. The support pin 283 projects from the base plate 281 toward the cold cathode tubes 17 to support the optical member 15 that is provided on the front side from the cold cathode tubes 17.

In the configuration of above embodiments, the relay electrodes 652, 752 do not have a function for positioning the cold cathode tubes 17 in their arrangement direction and the cold cathode tubes 17 are held and positioned only by the openings 19a of the lamp holder 19 (see FIG. 44). With using the lamp clip 280 of this modification to position the cold cathode tubes 17 (especially in their arrangement direction), attachment workability of the cold cathode tubes 17 is improved and problems such as a position gap of the cold cathode tubes 17 are less likely to occur. The lamp clip 280 has a function for urging the cold cathode tubes 17 toward the chassis 14 since it is configured to hold the cold cathode tubes 17 and to be attached to the chassis 14. Therefore, in such a case, the lamp clip 280 also urges the relay electrodes 652, 752 of the cold cathode tubes 17 toward the placing surface.

[Fourth Modification]

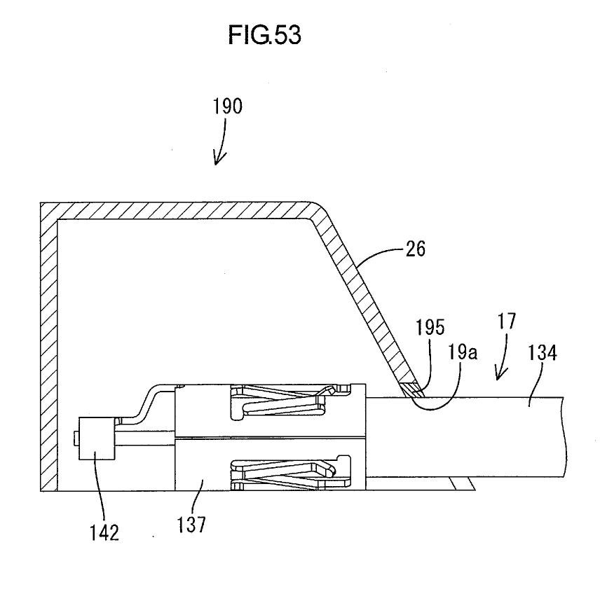

One modification of the lamp holder 19 that is the light source cover is illustrated in FIG. 53. FIG. 53 is an explanatory view illustrating a cross sectional configuration in a direction crossing to the longitudinal direction of a lamp holder 190 according to a fourth modification.

The lamp holder 190 of this modification includes a buffer member 195 at each opening 19a and in a state that the lamp holder 190 covers at least the ferrule 136 of the cold cathode tube 17 as illustrated in FIG. 53, the buffer member 195 is between the lamp holder 190 and the cold cathode tube 17. The buffer member 195 eases mechanical shock caused between the lamp holder 190 and the cold cathode tube 17 and sponge-like PORON is used for the buffer member 195 in this modification.

This configuration prevents that the lamp holder 190 excessively urges the cold cathode tubes 17 and damage or break them. That is, the buffer member 195 eases the urging force and ensures appropriate contact between the cold cathode tube 17 and the placing surface 653a. A material of the buffer member 195 is not limited if it can absorb the urging force such as a cloth.

[Fifth Modification]

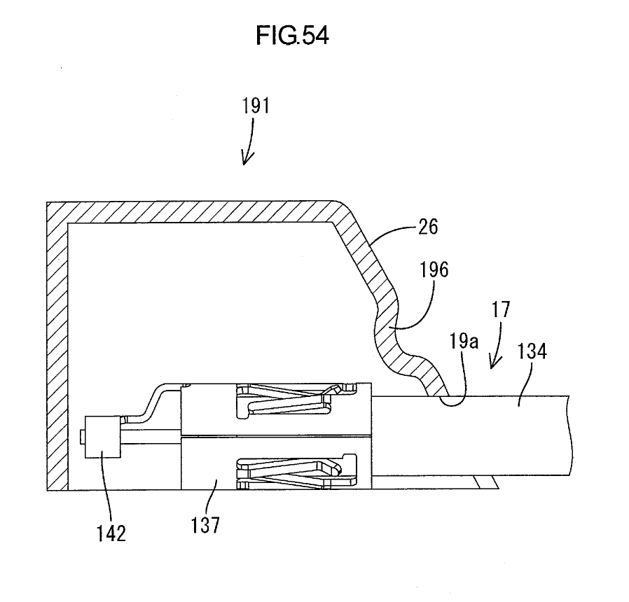

Another modification of the lamp holder 19 that is the light source cover is illustrated in FIG. 54. FIG. 54 illustrates an explanatory view illustrating a cross sectional configuration in a direction crossing to the longitudinal direction of a lamp holder 191 according to a fifth modification.

In the lamp holder 191 of this modification, a portion of the sloped cover 26 closer to the opening 19a, that is an urging portion 196 that comes in contact with the cold cathode tube 17 and urges the cold cathode tube toward the placing surface 653a is configured to be accordion-folded and elastically deformable. With the lamp holder 191 provided with such an urging member 196, it is prevented that the lamp holder 191 excessively urges the cold cathode tubes 17 and damages or breaks them. Namely, the urging member 196 that is configured to be accordion-folded to be elastically deformed eases a urging force and ensures appropriate contact between the cold cathode tube 17 and the placing surface 653a.

[Sixth Modification]

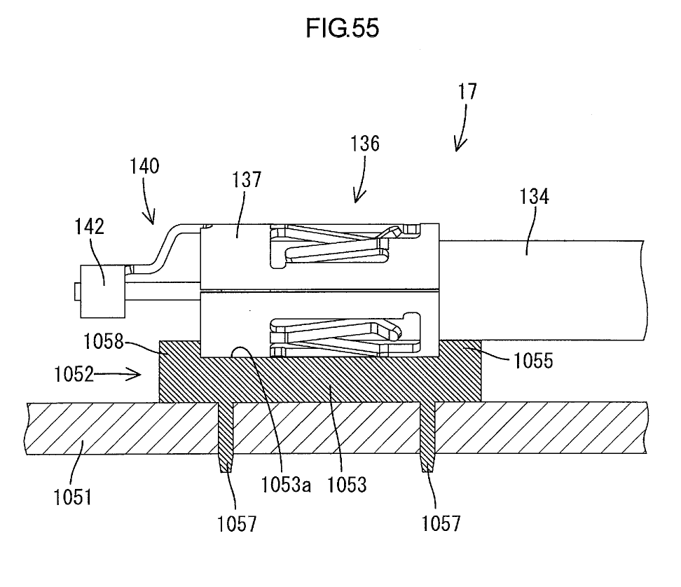

Another modification of the relay electrode 652 is illustrated in FIG. 55. FIG. 55 is an explanatory view illustrating a connecting relation between the cold cathode tube 17 and a relay electrode 1052 according to a sixth modification.

The relay electrode 1052 illustrated in FIG. 55 is wholly made of conductive rubber and configured to include a base 1053 formed in a chip or a rectangular shape and walls (light source movement restricting member) 1055, 1058 provided at a front end and a rear end of the base 1053 respectively and legs 1057 provided on a rear surface of the base 1053. In such a case, since the relay electrode 1052 is wholly made of conductive rubber, elasticity is applied to the relay electrode 1052. This elasticity ensures reliable contact between the ferrule 136 and the placing surface 1053a even if a slight position gap (relative movement) is caused between the two components. Accordingly, the reliable conductivity is ensured. If a dimension error in manufacturing occurs in the relay body 1052, the cold cathode tube 17 and the lamp holder 19, the elasticity compensates for the error to ensure the reliable contact between the ferrule 136 and the placing surface 1053a. Similar to the second modification, the walls 1055, 1058 restrict the axial movement of the cold cathode tube 17 in the state in that the cold cathode tube 17 is placed on the placing surface 1053a.

### Other Embodiments

(1) In the above embodiments, the discharge tubes that are driven in parallel are not limited to the cold cathode tubes but may be hot cathode tubes.

(2) The display panel 11 of the liquid crystal display device 10 may include switching components other than TFTs. For example, MIMs (Metal Insulator Metal) or other types of switching components can be used. The display device of the present invention is not limited to the liquid crystal display device and various kinds of display devices including lighting devices provided behind display panels can be used.

1. A lighting device comprising:
a number of discharge tubes that are arranged parallel to each other; and
a power source configured to supply driving power to drive the discharge tubes in parallel, wherein:
the driving power is supplied to the discharge tubes so that the driving power supplied to one end side and another end side of each of the discharge tubes in opposite phases; and
a capacitor is connected to the one end side of the discharge tubes between the power source and each of the discharge tubes, and the capacitor is disposed between the power source and each of the discharge tubes to make a current amount of the driving power supplied to each of the discharge tubes to be constant.

2. The lighting device according to claim 1, wherein the power source includes a transformer that outputs the driving power in opposite phases.

3. The lighting device according to claim 1, wherein the power source supplies the driving power to the one end side of the discharge tube that is connected to the capacitor of the discharge tube so that the driving power supplied to the one end side is higher than that supplied to the other end side.

4. The lighting device according to claim 1, wherein:
the power source includes a transformer having a primary coil, a first secondary coil and a second secondary coil, the first secondary coil and the second secondary coil are arranged to correspond to the primary coil, the first secondary coil has a relatively great number of coil turns and the second secondary coil has a relatively small number of coil turns; and
the first secondary coil is connected to the one end side of each discharge tube to which the capacitor is connected, and the second secondary coil is connected to the other end side of each discharge tube.

5. The lighting device according to claim 1, further comprising:
a support member configured to support end portions of the discharge tubes; and
a number of connecting terminals provided on the support member and each of the connecting terminals configured to hold each of the discharge tubes and connected to the power source to function as a terminal for supplying the driving power to each of the discharge tubes.

6. The lighting device according to claim 5, wherein the support member includes two support members and each of the support members is arranged along one ends and another ends of the discharge tubes to support the one ends and the other ends of the discharge tubes that are arranged parallel to each other.

7. The lighting device according to claim 5, wherein the capacitor is arranged on the support member.

8. The lighting device according to claim 5, wherein a ferrule that is electrically connectable to the connecting terminal is provided at an end portion of the discharge tube.

9. The lighting device according to claim 5, wherein:
each of the discharge tubes includes a linear glass tube, an outer lead linearly extending from two ends of the glass so as to be coaxial with the glass tube, and a ferrule electrically connected to the outer lead and provided at two ends of the glass tube; and
the ferrule is electrically connected to the connecting terminal.

10. The lighting device according to claim 5, wherein:
each of the discharge tubes includes a linear glass tube, and outer leads extending linearly from two ends of the glass tube so as to be coaxial with the glass tube;
the connection terminal includes a relay body made of conductive rubber and having an opening to which the outer lead is inserted; and
the outer lead is inserted to the opening of the relay body to be in elastically contact with an inner surface of the opening.

11. The lighting device according to claim 10, wherein the opening formed in the relay body has a diameter smaller than an outer diameter of the outer lead when the outer lead is not inserted to the opening.

12. The lighting device according to claim 1, wherein a relay electrode is arranged between each capacitor and a corresponding discharge tube and the discharge tube has a terminal portion for receiving supply of the driving power;
the relay electrode has a placing surface on which the terminal portion is placed and the driving power can be supplied to the discharge tubes with the terminal portion being placed on the placing surface; and
an urging member is provided separately from the relay electrode to urge the discharge tubes toward the placing surface of the relay electrode.

13. The lighting device according to claim 12, further comprising a support member configured to support end portions of the discharge tubes, wherein the relay electrode and the capacitor are arranged on the support member.

14. The lighting device according to claim 12, wherein:
the relay electrode includes an elastic member on the placing surface; and
the elastic member is disposed between the placing surface and the terminal portion in an elastically deformed state with the terminal portion being placed on the placing surface.

15. The lighting device according to claim 12, further comprising a discharge tube covering member configured to cover end portions of the discharge tubes, wherein the discharge tube covering member urges the discharge tubes toward the placing surface side as the urging member.

16. The lighting device according to claim 15, wherein:
the discharge tube covering member includes a buffer member; and
the buffer member is disposed between the discharge tube covering member and the discharge tubes with the discharge tube covering member covering the discharge tubes.

17. The lighting device according to claim 15, wherein the discharge tube covering member includes an urging member configured to come in contact with the discharge tube and urge the discharge tube toward the placing surface; and
the urging member is formed to be accordion-folded and elastically deformable.

18. The lighting device according to claim 12, further comprising:
a discharge tube movement restricting member configured to restrict movement of the discharge tube along an axial direction of the discharge tube with the terminal being placed on the placing surface.

19. The lighting device according to claim 18, wherein the discharge tube movement restricting member comprises a wall extending upwardly from the placing surface at an end of the relay electrode.

20. The lighting device according to claim 12, wherein:
the discharge tube is formed in a tubular shape and the terminal portion is formed in a tubular shape corresponding to a shape of the discharge tube; and
the relay electrode comprises an arc-shaped receiving member configured to receive a lower portion of the terminal portion with the terminal portion being placed on the placing surface.

21. The lighting device according to claim 20, wherein the arc-shaped receiving member has a cross section in a direction crossing to the axial direction of the discharge tube equal to or smaller than a semi-circular shape.

22. The lighting device according to claim 12, wherein the relay electrode is formed of conductive rubber.

23. The lighting device according to claim 12, wherein the discharge tube comprises a linear glass tube, and a ferrule configured to surround an end of the glass tube and function as the terminal.

24. A display device comprising:
a lighting device according to claim 1; and
a display panel configured to display using light from the lighting device.

25. The display device according to claim 24, wherein the display panel is a liquid crystal panel using liquid crystal.

26. A television receiver comprising a display device according to claim 24.
